(19) United States
(12) Patent Application Publication
(10) Pub. No.: US 2019/0111768 A1
(43) Pub. Date: Apr. 18, 2019

(54) AIR CONDITIONING APPARATUS FOR VEHICLE

(71) Applicant: DENSO CORPORATION, Kariya-city, Aichi-pref. (JP)

(72) Inventor: Yusuke KOMATSUBARA, Kariya-city (JP)

(73) Assignees: DENSO CORPORATION, Kariya-city, Aichi-pref. (JP); DENSO CORPORATION, Kariya-city, Aichi-pref. (JP)

(21) Appl. No.: 16/090,831

(22) PCT Filed: Jan. 26, 2017
(86) PCT No.: PCT/JP2017/002715

§ 371 Date: Oct. 3, 2018

(30) Foreign Application Priority Data
Apr. 5, 2016 (JP) 2016-075953

(51) Int. Cl. B60H 3/02; B60H 1/00

(52) U.S. Cl. CPC B60H 3/02; B60H 1/00528; B60H 2001/0015; B60H 2003/028; B60H 1/00028

(57) ABSTRACT

An air conditioning apparatus for a vehicle includes an air conditioning case in which an cooling air cooled by a cooling device and a heating air heated by a heating device flow into a temperature adjustment space. In the air conditioning case, a humidity adjustment passage guides a part of the heating air to an adsorbent as an air desorbing moisture from the adsorbent, and guides a part of the cooling air to the adsorbent as an air having moisture to be adsorbed by the adsorbent. The temperature adjustment space and the humidity adjustment passage are provided downstream of the cooling device and the heating device. An air passage extending from the humidity adjustment passage to a humidification duct is provided with a mixing inhibitor that inhibits mixing of the heating air and the cooling air and mixing of a dehumidifying air and a humidifying air.

### CROSS REFERENCE TO RELATED APPLICATION

This application is based on and incorporates herein by reference Japanese Patent Application No. 2016-075953 filed on Apr. 5, 2016.

### TECHNICAL FIELD

The present disclosure relates to an air conditioning apparatus for a vehicle, which air-conditions a vehicle interior.

### BACKGROUND ART

Conventionally, an air conditioning apparatus for a vehicle in which a moisture adsorbing rotor is rotatably disposed across an air introduction path for introducing an air into a vehicle interior and a regeneration path for discharging the air to an outside of the vehicle has been known (refer to, for example, Patent Literature 1). In the air conditioning apparatus for a vehicle disclosed in Patent Literature 1, the air heated by a heating heat exchanger disposed in the regeneration path is supplied to the moisture adsorbing rotor, to thereby desorb the moisture adsorbed onto the moisture adsorbing rotor and discharge the desorbed moisture to the outside of the vehicle.

### PRIOR ART LITERATURE

### Patent Literature

Patent Literature 1: JP 2006-240573 A

### SUMMARY OF INVENTION

Incidentally, unlike the air conditioning apparatus for a vehicle described in Patent Literature 1, the present inventor has studied an air conditioning apparatus for a vehicle capable of humidifying the vehicle interior. As described above, in the air conditioning apparatus for a vehicle disclosed in Patent Literature 1, the moisture adsorbed onto the moisture adsorbing rotor through the regeneration path is discharged to the outside of the vehicle. For that reason, the present inventor has studied the realization of humidification of the vehicle interior by the air conditioning apparatus for a vehicle by leveraging the moisture adsorbed onto the moisture adsorbing rotor through the regeneration path.

However, the air conditioning apparatus for a vehicle disclosed in Patent Literature 1 has a configuration in which the regeneration path, which is an air flow system of the air for adjusting a humidity inside the vehicle interior, is provided outside the air flow system of the air for adjusting the temperature inside the vehicle interior. Further, in the air conditioning apparatus for a vehicle disclosed in Patent Literature 1, a dedicated heating heat exchanger is disposed for the regeneration path.

In order to realize the structure described above, the air flow system of the air conditioning apparatus for a vehicle becomes complicated and there is a need to add a dedicated heater to the moisture adsorbing rotor, resulting in an increase in a body size of the air conditioning apparatus for a vehicle. For that reason, it is not realistic to humidify the vehicle interior by leveraging the technique disclosed in Patent Literature 1 in the air conditioning apparatus for a vehicle having a limited mounting space.

An object of the present disclosure is to provide an air conditioning apparatus for a vehicle capable of humidifying a vehicle interior with simplifying an air flow system and without adding a dedicated heater.

According to an aspect of the present disclosure, an air conditioning apparatus for a vehicle includes an air conditioning case having an air flow passage of air to be blown into the vehicle interior, and the air conditioning case houses a cooling device configured to cool air and a heating device configured to heat air. Further, the air conditioning apparatus includes: an adsorber including an adsorbent capable of adsorbing and desorbing moisture; and a humidification duct connected to the air conditioning case and configured to guide a humidifying air, which has been humidified by moisture desorbed from the adsorbent, into the vehicle interior.

The air conditioning case includes therein a temperature adjustment space provided downstream of the cooling device and the heating device in air flow, and configured to introduce thereinto a cooling air cooled by the cooling device and a heating air heated by the heating device. Further, the air conditioning case includes therein a humidity adjustment passage provided downstream of the cooling device and the heating device in air flow, and configured to guide a part of the heating air to the adsorbent as an air desorbing moisture from the adsorbent, and guide a part of the cooling air to the adsorbent as an air having moisture to be adsorbed by the adsorbent.

A mixing inhibitor is disposed in an air passage extending from the humidity adjustment passage to the humidification duct, and is configured to inhibit mixing of the heating air and the cooling air and inhibit mixing of the humidifying air and a dehumidifying air which has been dehumidified via adsorption of moisture by the adsorber.

According to the above configuration, humidification of the vehicle interior can be realized by supplying the air containing moisture desorbed from the adsorbent into the vehicle interior through the humidification duct. Further, the temperature adjustment space, through which the air for adjusting the temperature of the vehicle interior flows, and the humidity adjustment passage, through which the air for humidifying the vehicle interior flows, are provided in the air conditioning case on an air-flow downstream side of the cooling device and the heating device. For that reason, as compared with a configuration having another air flow system outside the air conditioning case for humidifying the vehicle interior, an air flow system can be simplified in the air conditioning apparatus for a vehicle.

In addition, in the air passage extending from the humidity adjustment passage to the humidification duct, the mixing inhibitor inhibits mixing of the heating air and the cooling air and inhibits mixing of the humidifying air and the dehumidifying air which has been dehumidified via adsorption of moisture by the adsorber.

According to the above configuration, since the heat loss of the air in the air passage extending from the humidity adjustment passage to the humidification duct is reduced, the moisture adsorbed onto the adsorbent can be desorbed by a part of the heating air without providing a dedicated heater for the adsorber.

Therefore, according to the air conditioning apparatus for a vehicle based on the viewpoint described above, the air conditioning apparatus for a vehicle capable of humidifying the vehicle interior can be realized with simplifying the air flow system and without adding a dedicated heater.

### BRIEF DESCRIPTION OF DRAWINGS

FIG. 1 is a schematic diagram showing an example of installation of an air conditioning apparatus for a vehicle on a vehicle according to a first embodiment.

FIG. 2 is a schematic cross-sectional view of an HVAC according to the first embodiment.

FIG. 3 is a cross-sectional view taken along a line III-III of FIG. 2.

FIG. 4 is a cross-sectional view taken along a line IV-IV of FIG. 2.

FIG. 5 is an illustrative diagram illustrating a flow of air flowing into an adsorbent when humidifying a vehicle interior in the air conditioning apparatus for a vehicle according to the first embodiment.

FIG. 6 is a block diagram showing a control device for the air conditioning apparatus for a vehicle according to a first embodiment.

FIG. 7 is an illustrative diagram illustrating a flow of air before and after an adsorber when humidifying the vehicle interior in the air conditioning apparatus for a vehicle according to the first embodiment.

FIG. 8 is a schematic cross-sectional view showing the air conditioning apparatus for a vehicle according to a first modification of the first embodiment.

FIG. 9 is a cross-sectional view taken along a line IX-IX in FIG. 8.

FIG. 10 is a schematic partially cross-sectional view showing an air conditioning apparatus for a vehicle according to a second modification of the first embodiment.

FIG. 11 is a schematic partially cross-sectional view showing the air conditioning apparatus for a vehicle according to a third modification of the first embodiment.

FIG. 12 is a schematic partially cross-sectional view showing the air conditioning apparatus for a vehicle according to a fourth modification of the first embodiment.

FIG. 13 is a schematic cross-sectional view showing a temperature adjustment unit in an air conditioning apparatus for a vehicle according to a second embodiment.

FIG. 14 is a schematic partially cross-sectional view showing the air conditioning apparatus for a vehicle according to a first modification of the second embodiment.

FIG. 15 is a schematic partially cross-sectional view showing the air conditioning apparatus for a vehicle according to a second modification of the second embodiment.

FIG. 16 is a schematic cross-sectional view showing a main portion of an air conditioning apparatus for a vehicle according to a third embodiment.

FIG. 17 is an illustrative diagram illustrating a flow of air before and after an adsorber when desorbing a moisture of an adsorbent in the air conditioning apparatus for a vehicle according to the third embodiment.

FIG. 18 is an illustrative diagram illustrating a flow of air before and after the adsorber when adsorbing the moisture to the adsorbent in the air conditioning apparatus for a vehicle according to the third embodiment.

FIG. 19 is a schematic cross-sectional view showing the air conditioning apparatus for a vehicle according to a first modification of the third embodiment.

FIG. 20 is an illustrative diagram illustrating a flow of air before and after the adsorber when desorbing the moisture of the adsorbent in the air conditioning apparatus for a vehicle according to the first modification of the third embodiment.

FIG. 21 is an illustrative diagram illustrating a flow of air before and after the adsorber when adsorbing the moisture to the adsorbent in the air conditioning apparatus for a vehicle according to the first modification of the third embodiment.

FIG. 22 is a schematic partially cross-sectional view showing the air conditioning apparatus for a vehicle according to a second modification of the third embodiment.

FIG. 23 is an illustrative diagram illustrating a flow of air before and after an adsorber when desorbing the moisture of the adsorbent in the air conditioning apparatus for a vehicle according to the second modification of the third embodiment.

FIG. 24 is an illustrative diagram illustrating a flow of air before and after the adsorber when adsorbing the moisture to the adsorbent in the air conditioning apparatus for a vehicle according to the second modification of the third embodiment.

FIG. 25 is a schematic partially cross-sectional view showing the air conditioning apparatus for a vehicle according to a third modification of the third embodiment.

FIG. 26 is an illustrative diagram illustrating a flow of air before and after the adsorber when desorbing the moisture of the adsorbent in the air conditioning apparatus for a vehicle according to the third modification of the third embodiment.

FIG. 27 is an illustrative diagram illustrating a flow of air before and after the adsorber when adsorbing the moisture to the adsorbent in the air conditioning apparatus for a vehicle according to the third modification of the third embodiment.

FIG. 28 is a schematic partially cross-sectional view showing the air conditioning apparatus for a vehicle according to a fourth modification of the third embodiment.

FIG. 29 is an illustrative diagram illustrating a flow of air before and after the adsorber when desorbing the moisture of the adsorbent in the air conditioning apparatus for a vehicle according to the fourth modification of the third embodiment.

FIG. 30 is an illustrative diagram illustrating a flow of air before and after the adsorber when adsorbing the moisture to the adsorbent in the air conditioning apparatus for a vehicle according to the fourth modification of the third embodiment.

### DETAILED DESCRIPTION

Hereinafter, multiple embodiments for implementing the present disclosure will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

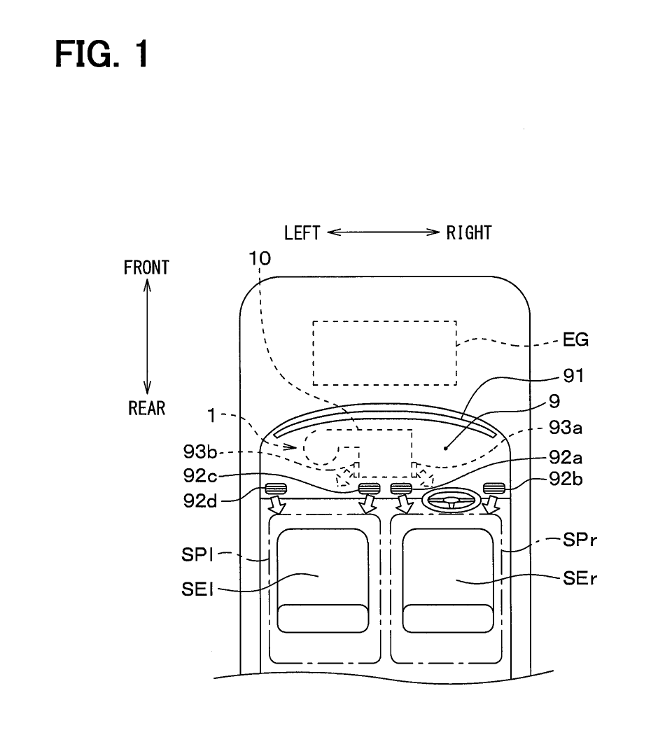

The present embodiment will be described with reference to FIGS. 1 to 7. It should be noted that arrows indicating up, down, left, right and front and rear shown in the drawings indicate an up-down direction, a right-left direction, and a front-rear direction when an air conditioning apparatus for a vehicle 1 is mounted on the vehicle.

In the present embodiment, an example in which the air conditioning apparatus for a vehicle 1 that performs air conditioning in a vehicle interior is applied to a vehicle that obtains a driving force for driving a vehicle from an internal combustion engine EG will be described. The air conditioning apparatus for a vehicle 1 can also be applied to, for example, a vehicle that obtains a driving force for driving the vehicle from an electric motor.

As shown in FIG. 1, the air conditioning apparatus for a vehicle 1 is provided with an HVAC (heating ventilation and air conditioning) 10 for adjusting an air blown into a vehicle interior to a desired temperature. The HVAC 10 is disposed inside an instrument panel 9 provided at a foremost portion in the vehicle interior.

The HVAC 10 is connected to a defroster blowing port 91, face blowing ports 92a to 92d, and foot blowing ports 93a and 93b through a duct not shown. The HVAC 10 is capable of blowing the air adjusted to the desired temperature into the vehicle interior through the defroster blowing port 91, the face blowing ports 92a to 92d, and the foot blowing ports 93a and 93b.

The defroster blowing port 91 is a blowing port configured to blow the air whose temperature has been adjusted by the HVAC 10 toward a window glass on a front of the vehicle not shown. The defroster blowing port 91 is provided at a foremost portion of the instrument panel 9.

The face blowing ports 92a to 92d are blowing ports configured to blow the air whose temperature has been adjusted by the HVAC 10 toward an upper body side of occupants seated in front seats SEr and SEl in the vehicle interior. The face blowing ports 92a to 92d are provided in the instrument panel 9 on a rear side of the defroster blowing port 91.

The face blowing ports 92a to 92d according to the present embodiment are configured to include right face blowing ports 92a and 92b for mainly blowing the air toward a right space SPr in which the right seat SEr in the vehicle interior is disposed. The face blowing ports 92a to 92d according to the present embodiment are configured to include left face blowing ports 92c and 92d for mainly blowing the air toward a left space SPl in which the left seat SEl inside the vehicle interior is disposed.

The foot blowing ports 93a and 93b are blowing ports configured to blow the air whose temperature has been adjusted by the HVAC 10 toward a lower body side of the occupants seated in the front seats SEr, SEl in the vehicle interior. The foot blowing ports 93a and 93b are open to an inside of the instrument panel 9.

The foot blowing ports 93a and 93b according to the present embodiment have a right foot blowing port 93a for mainly blowing the air toward the right space SPr in the vehicle interior and a left foot blowing port 93b for mainly blowing the air toward the left space SPl in the vehicle interior.

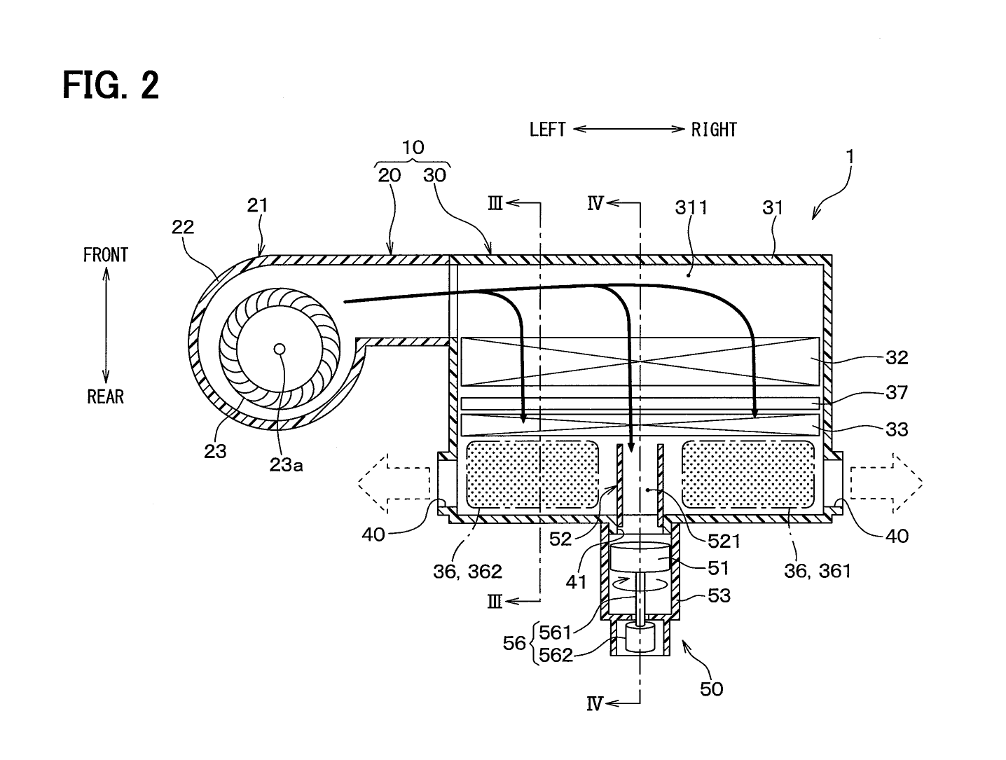

FIG. 2 schematically shows a cross section of the HVAC 10 when the HVAC 10 is cut vertically along the front-rear direction. As shown in FIG. 2, the HVAC 10 according to the present embodiment is roughly divided into two parts of a blower unit 20 and a temperature adjustment unit 30. The HVAC 10 is configured as an assembled body in which the blower unit 20 and the temperature adjustment unit 30 are assembled together by a fastening member not shown.

The HVAC 10 according to the present embodiment has a semi-center placement layout in which the blower unit 20 is disposed on the side of the left seat SEl, and the temperature adjustment unit 30 is disposed in the vicinity of a center between the respective seats SEr and SEl. The HVAC 10 may have a center placement layout in which, for example, both of the blower unit 20 and the temperature adjustment unit 30 are disposed in the vicinity of the center between the respective seats SEr and SEl.

The blower unit 20 is configured to suction at least one of a vehicle interior air (hereinafter also referred to as inside air) and a vehicle exterior air (hereinafter also referred to as outside air) and blows the suctioned air toward the temperature adjustment unit 30.

The blower unit 20 includes an inside-outside air switch device not shown and a blower 21. The inside-outside air switch device not shown disposed at an air flow most upstream portion in the blower unit 20. The inside-outside air switch device not shown is configured to set the air introduced into the blower 21 to at least one of the inside air and the outside air.

The blower 21 is provided on the air flow downstream side of the inside-outside air switch device, and blows the air introduced through the inside air and outside air switching device toward the temperature adjustment unit 30. The blower 21 includes a blower case 22 that forms an outer shell and a fan 23 that is accommodated in the blower case 22 and generates an air flow toward the temperature adjustment unit 30.

The blower case 22 is made of a resin (for example, polypropylene) having a certain degree of elasticity and also excellent in strength. The blower case 22 of the present embodiment is configured by a scroll casing in which an air flow passage of air is formed in a scroll shape. A portion of the blower case 22 on the air flow downstream side is connected to the air conditioning case 31 of the temperature adjustment unit 30 which will be described later.

The fan 23 according to the present embodiment is configured by a centrifugal fan that blows the air suctioned from one end side of a rotating shaft 23a in an axial direction toward a radially outer side of the rotating shaft 23a. It should be noted that the fan 23 is not limited to the centrifugal fan, but may be configured by, for example, an axial flow fan or a cross flow fan.

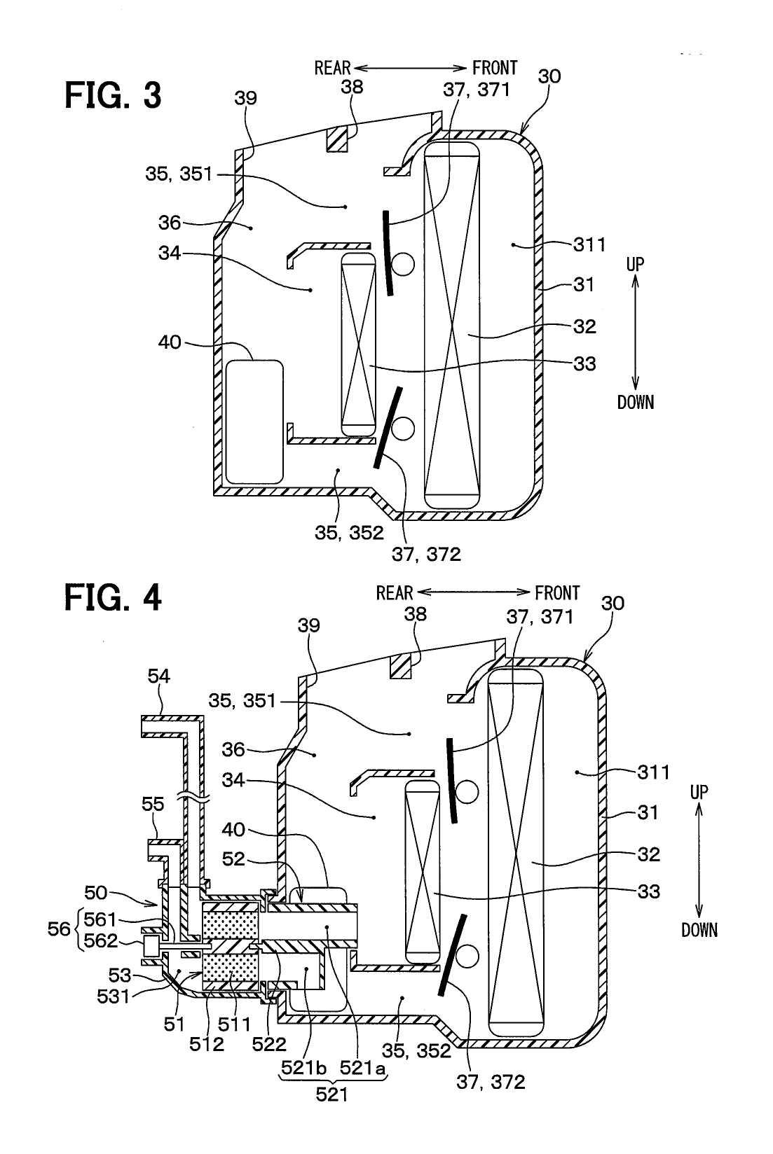

Subsequently, the temperature adjustment unit 30 will be described with reference to FIGS. 3 and 4. The temperature adjustment unit 30 shown in FIGS. 3 and 4 is configured to adjust the air blown from the blower unit 20 by the cooling heat exchanger 32 and the heating heat exchanger 33 accommodated in the temperature adjustment unit 30 to the desired temperature. In the temperature adjustment unit 30, the cooling heat exchanger 32 and the heating heat exchanger 33 are accommodated inside the air conditioning case 31 forming the outer shell.

The air conditioning case 31 is formed of a member that forms an air flow passage for air blown into the vehicle interior. The air conditioning case 31 according to the present embodiment is molded with a resin (for example, polypropylene) having a certain degree of elasticity and also excellent in strength.

A portion of the air conditioning case 31 on the air flow most upstream side is connected to the blower case 22 so that the air blown from the blower unit 20 flows in the air conditioning case 31. An air inflow passage 311 into which the air blown from the blower unit 20 flows is defined in the air conditioning case 31 at the air flow most upstream side.

The cooling heat exchanger 32 is disposed on the air flow downstream side of the air inflow passage 311 in the air conditioning case 31. The cooling heat exchanger 32 is a cooling device for cooling the air flowing inside the air conditioning case 31. The cooling heat exchanger 32 according to the present embodiment is configured by an evaporator that cools the air with the use of a latent heat of evaporation of the refrigerant flowing inside. The evaporator forms a vapor compression type refrigeration cycle together with a compressor, a condenser, and a pressure reducing mechanism not shown.

A hot air passage 34 for allowing the air cooled by the cooling heat exchanger 32 to flow toward the heating heat exchanger 33 side, and a cold air passage 35 for allowing the air cooled by the cooling heat exchanger 32 to flow around the heating heat exchanger 33 are configured on the downstream side of the cooling heat exchanger 32 in the air conditioning case 31.

In the hot air passage 34 according to the present embodiment, the heating heat exchanger 33 is disposed. The heating heat exchanger 33 is a heating device for heating the air flowing inside the air conditioning case 31. The heating heat exchanger 33 according to the present embodiment is configured by a heater core for heating the air with a coolant water of the engine EG as a heat source.

The cold air passage 35 according to the present embodiment includes an upper side cold air passage 351 provided on an upper side of the hot air passage 34 and a lower side cold air passage 352 provided at a lower side of the hot air passage 34. In other words, in the air conditioning case 31 according to the present embodiment, the upper side cold air passage 351 is provided on the upper side of the hot air passage 34 and the lower side cold air passage 352 is provided on the lower side of the hot air passage 34.

The air conditioning case 31 is provided with a temperature adjustment space 36 on the air flow downstream side of the hot air passage 34 and the cold air passage 35. The temperature adjustment space 36 is a space into which the heating air heated by the heating heat exchanger 33 and the cooling air cooled by the cooling heat exchanger 32 flow. The temperature of the air in the temperature adjustment space 36 varies depending on an air volume ratio of the heating air heated by the heating heat exchanger 33 and the cooling air cooled by the cooling heat exchanger 32.

Therefore, in the present embodiment, an air mixing door 37 is disposed on the air flow downstream side of the cooling heat exchanger 32 and on an inlet side of the hot air passage 34 and the cold air passage 35. The air mixing door 37 changes the air volume ratio of the cooling airs flowing into the hot air passage 34 and the cold air passage 35. The air mixing door 37 forms a temperature adjustment member for adjusting a temperature of the air in the temperature adjustment space 36.

As described above, the air conditioning case 31 according to the present embodiment is provided with the upper side cold air passage 351 and the lower side cold air passage 352. For that reason, the air mixing door 37 according to the present embodiment includes an upper side door 371 for opening and closing the upper side cold air passage 351 and a lower side door 372 for opening and closing the lower side cold air passage 352. In the present embodiment, both the upper side door 371 and the lower side door 372 of the air mixing door 37 are configured by slide doors. The upper side door 371 and the lower side door 372 of the air mixing door 37 are not limited to the slide doors, but may be configured by butterfly doors, for example.

Multiple opening portions 38, 39, and 40 are provided on the air flow most downstream portion of the air conditioning case 31. The openings 38, 39, and 40 are configured to blow the air adjusted to a desired temperature in the temperature adjustment space 36 to an outside of the air conditioning case 31. Specifically, the air conditioning case 31 according to the present embodiment is provided with a defroster opening portion 38, a face opening portion 39, and foot opening portions 40.

The defroster opening portion 38 communicates with the defroster blowing port 91 through a duct not shown. The defroster opening portion 38 is provided in a wall surface of the air conditioning case 31 on the upper side and the front side. The temperature adjustment unit 30 according to the present embodiment is configured to open and close the defroster opening portion 38 by a defroster door not shown.

The face opening portion 39 communicates with the face blowing ports 92a to 92d through ducts not shown. The face opening portion 39 is provided in a wall surface of the air conditioning case 31 on the upper side of the air conditioning case 31 and on a rear side from the defroster blowing port 91. The temperature adjustment unit 30 according to the present embodiment is configured to open and close the face opening portion 39 by a face door not shown.

The foot opening portions 40 communicate with the foot blowing ports 93a and 93b through ducts not shown. The foot opening portions 40 are provided on the respective side wall surfaces of the air conditioning case 31 on the lower side of the air conditioning case 31 and in the right and left direction of the air conditioning case 31. The temperature adjustment unit 30 according to the present embodiment is configured to open and close the foot opening portions 40 by foot doors not shown.

In addition, the air conditioning case 31 according to the present embodiment is provided with an intermediate opening portion 41 that blows a part of the heating air heated by the heating heat exchanger 33 and a part of the cooling air cooled by the cooling heat exchanger 32 toward the outside of the air conditioning case 31. The intermediate opening portion 41 is configured to connect a part of components of a humidifier 50 which will be described later. The intermediate opening portion 41 is provided on the lower side of the air conditioning case 31 and substantially in the center of the air conditioning case 31 in the right and left direction.

The air conditioning apparatus for a vehicle 1 according to the present embodiment is configured to enable a humidifying air for humidifying the vehicle interior to be generated with the use of the heating air heated by the heating heat exchanger 33 and the cooling air cooled by the cooling heat exchanger 32 in the temperature adjustment unit 30. In the present embodiment, the components that realize a humidifying function in the air conditioning apparatus for a vehicle 1 function as the humidifier 50 that humidifies the vehicle interior.

As shown in FIG. 4, the humidifier 50 is connected to the intermediate opening portion 41 of the air conditioning case 31. The humidifier 50 according to the present embodiment includes an adsorber 51, a passage formation member 52, a connection portion 53, a humidification duct 54, a dehumidification duct 55, and a drive mechanism 56.

The adsorber 51 includes an adsorbent 511 for adsorbing and desorbing a moisture and a holding member 512 for holding the adsorbent 511. The adsorber 51 according to the present embodiment is formed in a cylindrical outer shape. The adsorbent 511 is disposed in a state of being air-permeable so that the air can flow inside the adsorber 51.

In the present embodiment, a polymer adsorbent of an organic material is employed as the adsorbent 511. Incidentally, the adsorbent 511 is not limited to a polymer adsorbent, and for example, zeolite or silica gel of an inorganic material can be employed.

The passage formation member 52 is a member providing a humidity adjustment passage 521 that guides a part of the cooling air cooled by the cooling heat exchanger 32 to the adsorbent 511 and also guides a part of the heating air heated by the heating heat exchanger 33 to the adsorbent 511. The passage formation member 52 is configured as a separate part from the air conditioning case 31.

The passage formation member 52 according to the present embodiment is provided inside the air conditioning case 31 so that the heating air heated by the heating heat exchanger 33 and the cooling air cooled by the cooling heat exchanger 32 are introduced into the humidity adjustment passage 521.

Specifically, the passage formation member 52 according to the present embodiment is disposed in the vicinity of an outlet of the lower side cold air passage 352 of the hot air passage 34 and the cold air passage 35 inside the air conditioning case 31. The passage formation member 52 according to the present embodiment is provided with a partition plate 522 so that the air cooled by the cooling heat exchanger 32 and the air heated by the heating heat exchanger 33 are not mixed with each other inside the passage formation member 52. In other words, the humidity adjustment passage 521 is partitioned by the partition plate 522 into a hot air introduction passage 521a through which a part of the air heated by the heating heat exchanger 33 flows and a cold air introduction passage 521b through which a part of the air cooled by the cooling heat exchanger 32 flows.

In the present embodiment, the partition plate 522 functions as a mixing inhibitor that inhibits the heating air and the cooling air from being mixed with each other in the humidity adjustment passage 521. In addition, in the present embodiment, the partition plate 522 forms a partition forming portion that defines the hot air introduction passage 521a and the cold air introduction passage 521b on the air flow upstream side of the adsorber 51.

Further, as shown in FIG. 2, the passage formation member 52 according to the present embodiment is provided substantially in the center of the air conditioning case 31 in the right-left direction inside the air conditioning case 31. In other words, the passage formation member 52 is disposed inside the air conditioning case 31 so that a part of the temperature adjustment space 36 is separated into a right temperature adjustment space 361 that adjust the temperature of the air blown to a right space SPr of the vehicle interior and a left temperature adjustment space 362 that adjust the temperature of the air blown to a left space SPl. In the passage formation member 52 according to the present embodiment, the outlet side portion on the air flow downstream side is connected to the intermediate opening portion 41 defined in the air conditioning case 31.

Returning to FIG. 4, the humidifier 50 according to the present embodiment is provided with a connection portion 53 that connects an outlet side portion of the passage formation member 52 to an inlet side portion of the humidification duct 54 which will be described later. The connection portion 53 according to the present embodiment is connected to the outlet side portion of the passage formation member 52 through the intermediate opening portion 41 defined in the air conditioning case 31. The connection portion 53 according to the present embodiment is disposed outside the air conditioning case 31. The connection portion 53 is configured as a separate part from the air conditioning case 31.

The adsorber 51 described above is accommodated inside the connection portion 53 of the present embodiment. In other words, in the present embodiment, a space 531 inside the connection portion 53 defines a space for accommodating the adsorber 51.

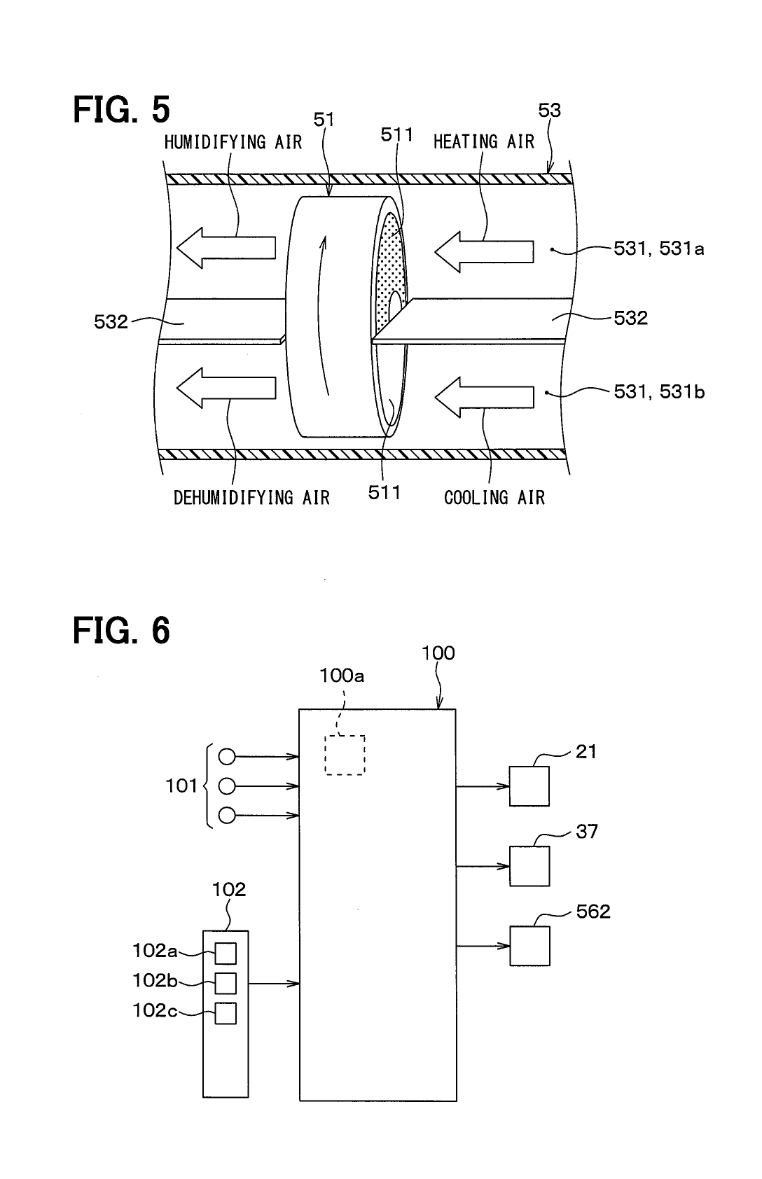

As shown in FIG. 5, the space 531 inside the connection portion 53 according to the present embodiment is partitioned into a moisture desorption space 531a through which the heating air heated by the heating heat exchanger 33 flows, and a moisture absorption space 531b through which the cooling air cooled by the cooling heat exchanger 32 flows.

Specifically, the connection portion 53 is provided with partition members 532 that partition the space 531 inside the connection portion 53 into the moisture desorption space 531a through which the heating air heated by the heating heat exchanger 33 flows and the moisture absorption space 531b through which the cooling air cooled by the cooling heat exchanger 32 flows. In other words, the space 531 in which the adsorber 51 is accommodated is partitioned into the moisture desorption space 531a and the moisture absorption space 531b by the partition members 532.

The partition members 532 according to the present embodiment are disposed on both of the air flow upstream side and the air flow downstream side of the adsorber 51. The partition members 532 according to the present embodiment are disposed close to the adsorber 511 in a state where there is substantially no gap between end portions of the partition members 532 and the adsorbent 511 so that the air present in the moisture desorption space 531a and the air present in the moisture absorption space 531b are not substantially mixed with each other.

The adsorber 51 according to the present embodiment is accommodated inside the connection portion 53 across both of the moisture desorption space 531a and the moisture absorption space 531b. For that reason, in the adsorbent 511 existing in the moisture desorption space 531a, the moisture adsorbed onto the adsorbent 511 is desorbed by the heating air flowing through the moisture desorption space 531a. As a result, the air that has passed through the moisture desorption space 531a becomes a humidifying air including the moisture desorbed from the adsorbent 511.

In the adsorbent 511 existing in the moisture absorption space 531b, the moisture contained in the cooling air flowing through the moisture absorption space 531b is adsorbed. As a result, the air that has passed through the moisture absorption space 531b becomes a dehumidifying air dehumidified by the adsorbent 511.

In the present embodiment, the partition members 532 function as a mixing inhibitor that inhibits the heating air and the cooling air from being mixed with each other and inhibits the dehumidifying air and the humidifying air from being mixed with each other, in the air passage extending from the humidity adjustment passage 521 to the humidification duct 54, which will be described later.

Returning to FIG. 4, the connection portion 53 is connected with an inlet side portion of the humidification duct 54 on the air flow downstream side of the moisture desorption space 531a. In addition, the connection portion 53 is connected with an inlet side portion of the dehumidification duct 55 on the air flow downstream side of the moisture absorption space 531b.

The humidification duct 54 is configured to guide the humidifying air containing the moisture desorbed from the adsorbent 511 to a space to be humidified in the vehicle interior. The outlet side portion of the humidification duct 54 according to the present embodiment on the air flow downstream side is open to the space to be humidified in the vehicle interior. For that reason, the humidifying air containing the moisture desorbed from the adsorbent 511 is blown to the space to be humidified in the vehicle interior. As the space to be humidified in the vehicle interior, for example, there is a space in which an occupant's face or the like is located.

On the other hand, the dehumidification duct 55 is configured to guide the dehumidifying air dehumidified by the adsorbent 511 to a space away from the space from which the humidifying air is blown. The outlet side portion of the dehumidification duct 55 according to the present embodiment on the air flow downstream side is open to the inside of the instrument panel 9. For that reason, the dehumidifying air dehumidified by the adsorbent 511 is discharged to the inside of the instrument panel 9.

Incidentally, as described above, in the humidifier 50 according to the present embodiment, the moisture adsorbed onto the adsorbent 511 existing in the moisture desorption space 531a is desorbed, thereby being capable of generating the humidifying air. However, the amount of moisture that can be desorbed by the adsorbent 511 existing in the moisture desorption space 531a is finite.

Therefore, the humidifier 50 according to the present embodiment includes the drive mechanism 56 that moves the adsorbent 511 of the adsorber 51 between the moisture desorption space 531a and the moisture absorption space 531b. The drive mechanism 56 is configured to move at least a part of the adsorbent 511 existing in the moisture desorption space 531a to the moisture absorption space 531b and move at least a part of the adsorbent 511 existing in the moisture absorption space 531b to the moisture desorption space 531a by rotating the adsorber 51.

Specifically, the drive mechanism 56 includes a rotating shaft 561 that passes through a center of the adsorber 51 and is coupled to the adsorber 51, and an electric motor 562 with a speed reducer which rotationally drives the rotating shaft 561. The rotating shaft 561 is rotatably supported by the connection portion 53, and when a driving force is transmitted to the rotating shaft 561 from the electric motor 562, the rotating shaft 561 rotates together with the adsorber 51 inside the connection portion 53. As a result, a part of the adsorbent 511 existing in the moisture desorption space 531a of the adsorber 51 moves to the moisture absorption space 531b, and a part of the adsorbent 511 existing in the moisture absorption space 531b of the adsorber 51 moves to the moisture desorption space 531a.

The electric motor 562 according to the present embodiment continuously rotationally drives the rotating shaft 561 in one direction. As a result, the adsorbent 511 from which the moisture has been sufficiently desorbed in the moisture desorption space 531a in the adsorber 51 can be moved to the moisture absorption space 531b, and the adsorbent 511 that has sufficiently adsorbed the moisture in the moisture absorption space 531b in the adsorber 51 can be moved to the moisture desorption space 531a.

Next, a description will be given of the control device 100 which is an electric control unit of the air conditioning apparatus for a vehicle 1 with reference to FIG. 6. The control device 100 shown in FIG. 6 includes a microcomputer including a CPU and a storage unit such as a ROM and a RAM, and peripheral circuits of the microcomputer. The control device 100 performs various calculations and processes based on control programs stored in the storage unit, and controls the operation of various devices connected to an output side of the control device 100. A storage unit of the control device 100 is configured by a non-transitory tangible storage medium.

The control device 100 according to the present embodiment integrates a control device for controlling the operation of various devices of the HVAC 10 and a control device for controlling the operation of various devices of the humidifier 50 into one piece. The air conditioning apparatus for a vehicle 1 may be configured such that the control device for controlling the operation of the various devices of the HVAC 10 and the control device for controlling the operation of various devices of the humidifier 50 are provided separately.

The input side of the control device 100 is connected with various sensor groups 101 for air conditioning control and an operation panel 102 for air conditioning control and humidification control. The various sensor groups 101 for the air conditioning control includes an inside air temperature sensor for detecting an inside air temperature, an outside air temperature sensor for detecting an outside air temperature, an insolation sensor for detecting the amount of insolation in the vehicle interior, an evaporator temperature sensor for detecting a temperature of the cooling heat exchanger 32, and the like.

The operation panel 102 is provided with an air conditioning operation switch 102a, a humidifying operation switch 102b, a temperature setting switch 102c, and the like. The air conditioning operation switch 102a is a switch for switching on and off the air conditioning operation by the HVAC 10. The humidifying operation switch 102b is a switch for switching on and off the humidifying operation of the humidifier 50. The temperature setting switch 102c is a switch for setting a target temperature of the air blown from the temperature adjustment unit 30.

The output side of the control device 100 is connected with various devices as the control target such as the blower 21, the air mixing door 37, the electric motor 562 of the drive mechanism 56, and so on. The control device 100 is configured to output a control signal to the blower 21, the air mixing door 37, the electric motor 562 of the drive mechanism 56, and the like.

The control device 100 according to the present embodiment is a device that integrates hardware and software for controlling the operation of various devices connected to the output side of the control device 100. As the control unit integrated in the control device 100, there are a humidification control unit 100a for executing a humidification process for humidifying the vehicle interior with the humidifier 50, and the like.

Next, the operation of the HVAC 10 and the humidifier 50 according to the present embodiment will be described. First, an outline of the operation of the HVAC 10 will be described. In the HVAC 10, when the air conditioning operation switch 102a is turned on, the control device 100 calculates a target blowing temperature TAO of the blowing air blown into the vehicle interior based on the detection signals of the various sensor groups 101 for air conditioning control and a set temperature of the temperature setting switch 102c. The control device 100 controls the operations of the various devices such as the blower 21 and the air mix door 37 in the HVAC 10 so that the temperature of the blowing air blown into the vehicle interior approaches the target blowing temperature TAO.

As described above, in the HVAC 10, the control device 100 controls the various devices according to the detection signals or the like of the various sensor groups 101 for air conditioning control, thereby being capable of realizing an appropriate temperature adjustment in the vehicle interior required by the user.

Next, the operation of the humidifier 50 will be described. In the humidifier 50, when both of the air conditioning operation switch 102a and the humidifying operation switch 102b are turned on, the control device 100 operates the drive mechanism 56 to rotate the adsorber 51 at a predetermined rotation speed. In this case, when the lower side door 372 of the air mixing door 37 is in a position to close any one of the hot air passage 34 and the lower side cold air passage 352, the control device 100 controls the lower side door 372 to a position where both of the hot air passage 34 and the lower side cold air passage 352 are opened.

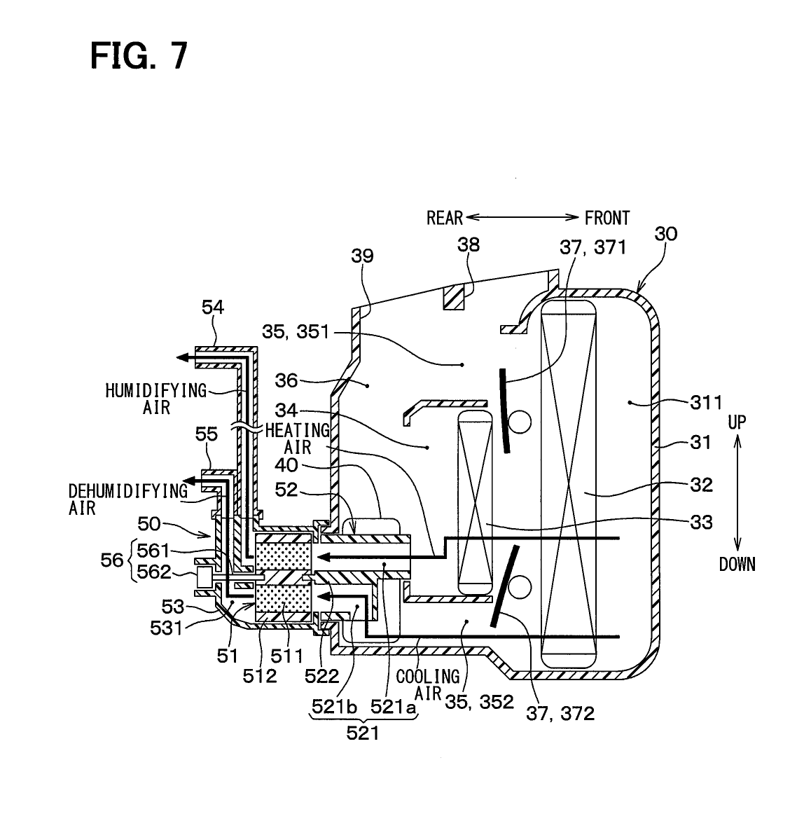

As a result, as shown in FIG. 7, a part of the cooling air cooled by the cooling heat exchanger 32 and a part of the heating air heated by the heating heat exchanger 33 are introduced into the connection portion 53 through the humidity adjustment passage 521.

The heating air introduced into the connection portion 53 is humidified by desorption of the moisture adsorbed onto the adsorbent 511 existing in the moisture desorption space 531a of the adsorber 51. In the present embodiment, since the adsorber 51 rotates inside the connection portion 53, the adsorbent 511 that has sufficiently adsorbed the moisture in the moisture absorption space 531b of the adsorber 51 moves to the moisture desorption space 531a. As a result, the heating air introduced into the connection portion 53 is continuously humidified by the adsorbent 511 present in the moisture absorption space 531b of the adsorber 51. The humidifying air humidified in the moisture desorption space 531a is blown toward the space to be humidified in the vehicle interior through the humidification duct 54.

On the other hand, the cooling air introduced into the connection portion 53 is dehumidified by the adsorbent 511 existing in the moisture absorption space 531b of the connection portion 53. In the present embodiment, since the adsorber 51 rotates inside the connection portion 53, the adsorbent 511 from which the moisture has been sufficiently desorbed in the moisture desorption space 531a in the adsorber 51 moves to the moisture absorption space 531b. As a result, the moisture contained in the cooling air introduced into the connection portion 53 is continuously adsorbed onto the adsorbent 511 existing in the moisture absorption space 531b of the adsorber 51. The air having passed through the moisture absorption space 531b is blown into the space inside the instrument panel 9 through the dehumidification duct 55. As a result, the cold air with a low humidity hardly flows into the vehicle interior.

The air conditioning apparatus for a vehicle 1 described above is configured to supply the air containing the moisture desorbed from the adsorbent 511 of the adsorber 51 to the vehicle interior through the humidification duct 54. For that reason, according to the air conditioning apparatus for a vehicle 1 of the present embodiment, the humidification in the vehicle interior can be realized.

The air conditioning apparatus for a vehicle 1 further includes the temperature adjustment space 36 through which the air for adjusting the temperature inside the vehicle interior flows and the humidity adjustment passage 521 through which the air for adjusting the humidity in the vehicle interior flows on the air flow downstream side of the cooling heat exchanger 32 and the heating heat exchanger 33 in the air conditioning case 31. For that reason, as compared with a configuration in which the air ventilation system for humidifying the vehicle interior is provided outside the air conditioning case 31, the air flow system can be simplified in the air conditioning apparatus for a vehicle.

In addition, in the air passage extending from the humidity adjustment passage 521 to the humidification duct 54, the partition plate 522 and the partition members 532 are provided as a mixing inhibitor that inhibits the heating air and the cooling air from being mixed with each other and inhibits the dehumidifying air and the humidifying air from being mixed with each other.

According to the above configuration, in the air passage extending from the humidity adjustment passage 521 to the humidification duct 54, a heat loss caused by mixture of airs having different temperatures is reduced. For that reason, in the air conditioning apparatus for a vehicle 1 according to the present embodiment, the moisture of the adsorbent 511 can be desorbed by a part of the heating air without adding a dedicated heater to the adsorber 51.

Therefore, according to the air conditioning apparatus for a vehicle 1 of the present embodiment, a configuration capable of humidifying the vehicle interior without adding the dedicated heater while simplifying the air flow system can be realized.

In addition, in the air conditioning apparatus for a vehicle 1 according to the present embodiment, the passage formation member 52 that provides the humidity adjustment passage 521 is provided inside the air conditioning case 31, and the humidity adjustment passage 521 and the temperature adjustment space 36 are provided as separate air flow passages.

According to the above configuration, the airs passing through the cooling heat exchanger 32 and the heating heat exchanger 33 can be properly distributed to the temperature adjustment space 36 and the humidity adjustment passage 521. For that reason, the vehicle interior can be humidified while exercising the function of adjusting the temperature in the vehicle interior in the air conditioning apparatus for a vehicle 1.

The temperature adjustment unit 30 of the air conditioning apparatus for a vehicle 1 is required to provide a comparable air conditioning performance for the right space SPr where the right seat SEr in which the occupant of the vehicle is seated is placed and the left space SPl where the left seat SEl is placed.

Taking the above fact into consideration, in the air conditioning apparatus for a vehicle 1 according to the present embodiment, the passage formation member 52 providing the humidity adjustment passage 521 is provided inside the air conditioning case 31 such that a part of the temperature adjustment space 36 is divided into the right temperature adjustment space 361 and the left temperature adjustment space 362. According to the above configuration, a right side and a left side of the temperature adjustment space 36 can be configured as symmetrical spaces. This is effective in that the air conditioning functions exerted on the right space SPr where the right seat SEr is placed and the left space SPr where the left seat SEl is placed in the vehicle interior can be maintained equally.

Furthermore, in the present embodiment, the adsorber 51 is disposed in the connection portion 53 connecting the outlet side portion of the humidity adjustment passage 521 and the inlet side portion of the humidification duct 54. This makes it possible to prevent a size of the temperature adjustment space 36 inside the air conditioning case 31 from changing due to the addition of the adsorber 51.

Furthermore, in the air conditioning apparatus for a vehicle 1 according to the present embodiment, the space 531 in which the adsorber 51 is accommodated is partitioned into the moisture desorption space 531a through which the heating air flows and the moisture absorption space 531b through which the cooling air flows. The air conditioning apparatus for a vehicle 1 according to the present embodiment is provided with the drive mechanism 56 for moving the adsorbent 511 of the adsorber 51 between the moisture desorption space 531a and the moisture absorption space 531b by rotating the adsorber 51.

According to the above configuration, the moisture adsorbed onto the adsorbent 511 in the moisture absorption space 531b is desorbed in the moisture desorption space 531a, and the moisture of the air flowing in the moisture absorption space 531b can be adsorbed onto the adsorber 511 from which the moisture is desorbed in the moisture desorption space 531a. For that reason, the air humidified by the adsorber 51 can be continuously provided to the vehicle interior.

Furthermore, in the air conditioning apparatus for a vehicle 1 according to the present embodiment, at least a part of the space 531 in which the adsorber 51 is accommodated is partitioned by the partition members 532 into the moisture desorption space 531a and the moisture absorption space 531b. According to the above configuration, the heat loss caused by the mixing of the heating air and the cooling air can be sufficiently reduced, and the deterioration of the humidifying effect in the vehicle interior due to the mixing of the humidifying air and the dehumidifying air can be sufficiently reduced.

In this example, the air conditioning case 31 of the HVAC 10 may have an opening for rear seat air conditioning, an opening portion for seat air conditioning, and the like in some cases. In the HVAC 10 having such a configuration, the humidifier 50 according to the present embodiment is connected to the opening portion for the rear seat air conditioning and the opening for the seat air conditioning provided in the air conditioning case 31, thereby being capable of easily providing the humidifying function.

### First Modification of First Embodiment

As shown in FIG. 7, in the first embodiment, the example in which the heating air heated by the heating heat exchanger 33 after passing through the cooling heat exchanger 32 is introduced into the adsorber 51 has been described. However, the present disclosure is not limited to the above configuration.

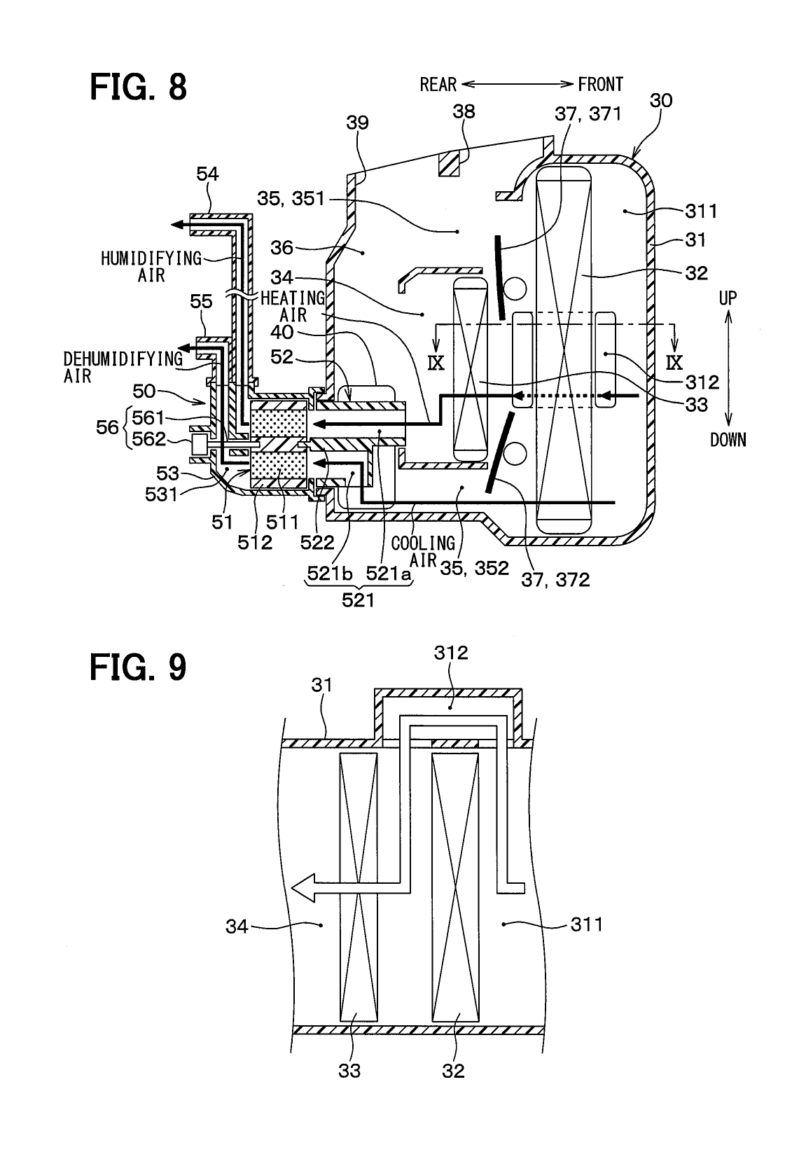

As shown in FIGS. 8 and 9, a bypass passage 312 for bypassing the cooling heat exchanger 32 may be added to the air conditioning case 31 of the air conditioning apparatus for a vehicle 1, and the heating air heated by the heating heat exchanger 33 after passing through the bypass passage 312 may be introduced into the adsorber 51.

### Second Modification of First Embodiment

In the first embodiment described above, the example in which the end portions of the partition members 532 are disposed close to the adsorbent 511 with substantially no gap so that the air present in the moisture desorption space 531a and the air present in the moisture absorption space 531b are not substantially mixed with each other has been described. However, the present disclosure is not limited to the above configuration.

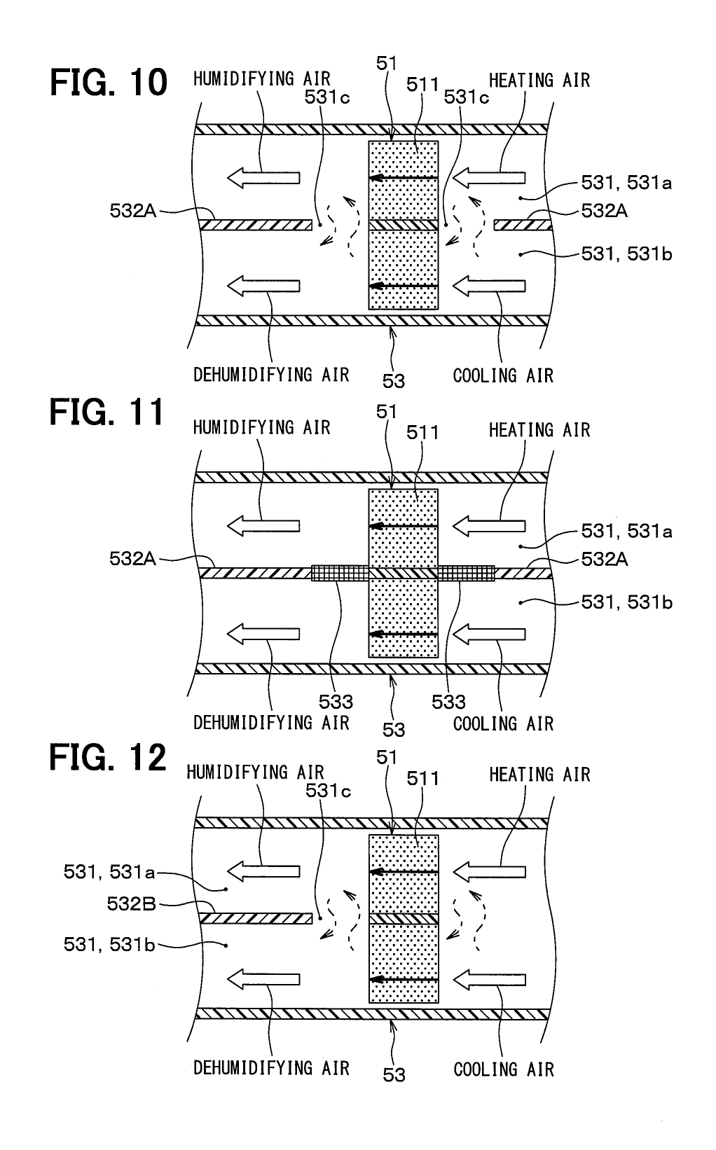

For example, as shown in FIG. 10, partition members 532A may be disposed in a state in which a predetermined gap 531c is provided between each of the partition members 532A and the adsorbent 511 in the space 531 in which the adsorber 51 is accommodated. According to the above configuration, since a contact between the adsorbent 511 and each of the partition members 532A is prevented, the rotation of the adsorber 51 can be prevented from stopping due to the contact with the partition members 532A. In the present modification, the partition plate 522 and the partition members 532A function as a mixing inhibitor that inhibits the heating air and the cooling air from being mixed with each other and inhibits the dehumidifying air and the humidifying air from being mixed with each other, in the air passage extending from the humidity adjustment passage 521 to the humidification duct 54.

However, in the configuration of the present modification, the air existing in the moisture desorption space 531a and the air existing in the moisture absorption space 531b are slightly mixed with each other, as indicated by broken line arrows in FIG. 10. For that reason, it is desirable that the gap 531c is set to a size within a range where a temperature difference between the heating air and the cooling air flowing into the adsorber 51 can be secured on the air flow upstream side of the adsorber 51. In addition, it is desirable that the gap 531c is set to a size within a range where a humidity difference between the humidifying air and the dehumidifying air flowing out of the adsorber 51 can be secured on the air flow downstream side of the adsorber 51.

### Third Modification of First Embodiment

In the second modification described above, the example in which the moisture desorption space 531a and the moisture absorption space 531b communicate with each other through the gap 531c between each of the partitioning members 532A and the adsorbent 511 has been described, but the present disclosure is not limited to the above configuration.

For example, as shown in FIG. 11, an elastic member 533 may be disposed between each of the partition members 532A and the adsorbent 511 such that the elastic members 533 block a communication between the moisture desorption space 531a and the moisture absorption space 531b.

It is desirable that the elastic members 533 are made of, for example, a foam member or a brush-like member so that a contact area of the elastic members 533 with the adsorbent 511 is reduced. With the configuration described above, the rotation of the adsorber 51 caused by the contact with the partition members 532A can be prevented from stopping while the heating air and the cooling air are inhibited from being mixed with each other. In the present modification, the partition plate 522, the partition members 532A, and the elastic member 533 function as a mixing inhibitor that inhibits the heating air and the cooling air from being mixed with each other, and inhibits the dehumidifying air and the humidifying air from being mixed with each other, in the air passage extending from the humidity adjustment passage 521 to the humidification duct 54.

### Fourth Modification of First Embodiment

In the first embodiment described above, the example in which the partition members 532 are disposed on both of the air flow upstream side and the air flow downstream side of the adsorber 51 has been described, but the present disclosure is not limited to the above configuration. The partition plate 522 is disposed inside the humidity adjustment passage 521 on the air flow upstream side of the adsorber 51. For that reason, on the air flow upstream side of the adsorber 51, the mixing of the heating air and the cooling air can be reduced by the partition plate 522 to some extent.

For that reason, for example, as shown in FIG. 12, a partition member 5328 may be disposed only on the air flow downstream side of the adsorber 51. In the present modification, the partition plate 522 and the partition member 5328 function as a mixing inhibitor that inhibits the heating air and the cooling air from being mixed with each other and inhibits the dehumidifying air and the humidifying air from being mixed with each other, in the air passage extending from the humidity adjustment passage 521 to the humidification duct 54.

In FIG. 12, an example is shown in which the partition member 5328 is disposed in a state where a predetermined gap 531c is provided between the partition member 5328 and the adsorbent 511, but the present disclosure is not limited to the above configuration. The partitioning member 5328 may be configured such that an elastic member for blocking a communication between the moisture desorption space 531a and the moisture absorption space 531b is provided as in the third modification described above.

### Second Embodiment

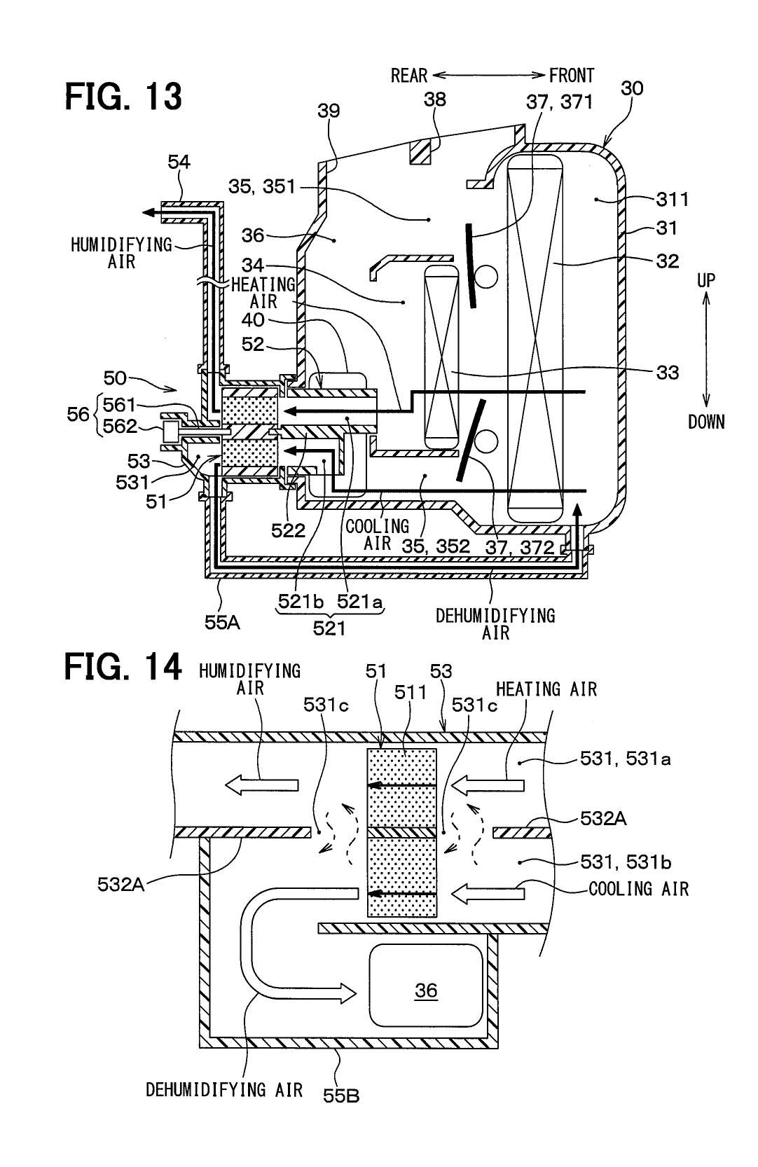

Next, a second embodiment will be described with reference to FIG. 13. FIG. 13 schematically shows a cross section of a temperature adjustment unit 30 of the present embodiment, which is taken at the center in a right-left direction along a front-back direction as in FIG. 4.

As shown in FIG. 13, in the present embodiment, a dehumidification duct 55A is connected to an air conditioning case 31 such that a dehumidifying air dehumidified by an adsorber 51 returns to an air flow upstream side of a cooling heat exchanger 32 inside an air conditioning case 31.

Specifically, an outlet side portion of the dehumidification duct 55A according to the present embodiment on the air flow downstream side is connected to a portion of the air conditioning case 31 providing an air inflow passage 311. In the present embodiment, the dehumidification duct 55A configures a circulation duct for returning an air dehumidified by an adsorbent 511 to an air flow upstream side of a cooling heat exchanger 32.

The other configuration is the same as in the first embodiment. The air conditioning apparatus for a vehicle 1 according to the present embodiment has a configuration common to that of the first embodiment. For that reason, the air conditioning apparatus for a vehicle 1 according to the present embodiment can obtain the same advantages as those in the first embodiment, which are obtained from the configuration common to the first embodiment.

In particular, in the present embodiment, the dehumidifying air dehumidified by an adsorbent 511 is returned to the air flow upstream side of the cooling heat exchanger 32. According to the above configuration, since the air dehumidified by the adsorbent 511 can be prevented from being supplied into the vehicle interior, the vehicle interior can be sufficiently humidified.

### First Modification of Second Embodiment

In the second embodiment described above, the configuration in which the dehumidifying air dehumidified by an adsorbent 511 is returned to the air flow upstream side of the cooling heat exchanger 32 has been described. However, the present disclosure is not limited to the above configuration.

For example, as shown in FIG. 14, a dehumidification duct 55B may be connected to a portion defining a temperature adjustment space 36 inside the air conditioning case 31 so that the dehumidifying air dehumidified by the adsorbent 511 is introduced into the temperature adjustment space 36.

In this example, partition members 532A may be disposed in a state in which a predetermined gap 531c is provided between each of the partition members 532A and the adsorbent 511 in the space 531 in which the adsorber 51 is accommodated. The partitioning member 532A may be configured such that an elastic member for blocking a communication between the moisture desorption space 531a and the moisture absorption space 531b is provided.

### Second Modification of Second Embodiment

In the second modification described above, the example in which the partition members 532A are disposed on both of the air flow upstream side and the air flow downstream side of the adsorber 51 has been described, but the present disclosure is not limited to the above configuration.

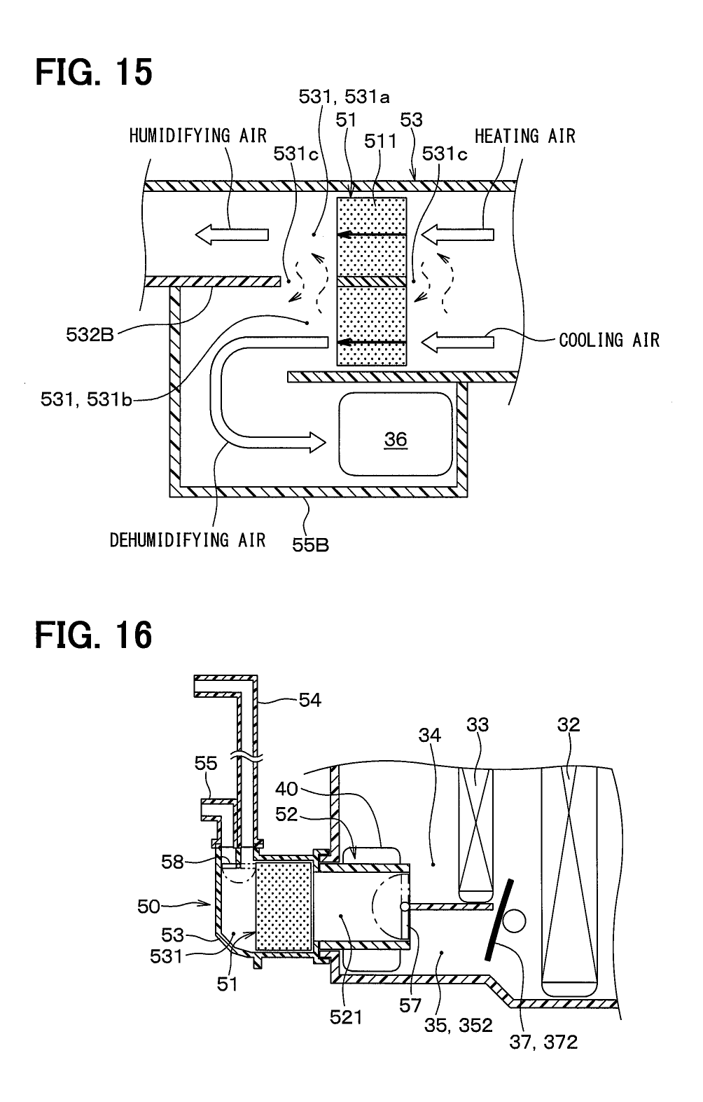

For example, as shown in FIG. 15, a partition member 5328 may be disposed only on the air flow downstream side of the adsorber 51. The partitioning member 5328 may be configured such that an elastic member for blocking a communication between the moisture desorption space 531a and the moisture absorption space 531b is provided.

### Third Embodiment

Next, a third embodiment will be described with reference to FIGS. 16 to 18. The present embodiment is different from the first embodiment in that an air humidified by an adsorbent 511 is intermittently supplied into a vehicle interior.

In a humidifier 50 according to the present embodiment, a passage formation member 52 providing a humidity adjustment passage 521 opens to an outlet side of a hot air passage 34 and a cold air passage 35. Unlike the first embodiment, a passage formation member 52 according to the present embodiment eliminates a partition plate 522 that partitions a humidity adjustment passage 521 into two passages. Although not shown, in the present embodiment, a partition member 532 for partitioning a space 531 inside a connection portion 53 into a moisture desorption space 531a and a moisture absorption space 531b is also eliminated.

Further, the humidifier 50 according to the present embodiment is installed so that an adsorber 51 does not move with respect to a connection portion 53. The humidifier 50 according to the present embodiment has a switching door 57 for switching an air to be introduced into the humidity adjustment passage 521 instead of a drive mechanism 56 of the first embodiment.

The switching door 57 according to the present embodiment is provided on an air inlet side of the humidity adjustment passage 521. In the present embodiment, the switching door 57 configures an introduction switching member which selectively introduces a heating air heated by a heating heat exchanger 33 and a cooling air cooled by a cooling heat exchanger 32 into the adsorber 51.

Furthermore, the humidifier 50 according to the present embodiment has an opening and closing door 58 for selectively opening and closing an opening of a humidification duct 54 on the air flow upstream side and an opening of a dehumidification duct 55 on the air flow upstream side. The opening and closing door 58 according to the present embodiment is provided on the air flow downstream side of the adsorber 51 in the connection portion 53.

The switching door 57 and the opening and closing door 58 are connected to an output side of a control device 100. The operation of the switching door 57 and the opening and closing door 58 is controlled according to a control signal from the control device 100. In the present embodiment, the switching door 57 and the opening and closing door 58 function as a mixing inhibitor that inhibits the heating air and the cooling air from being mixed with each other and inhibits the dehumidifying air and the humidifying air from being mixed with each other in the air passage extending from the humidity adjustment passage 521 to the humidification duct 54.

Subsequently, the operation of the humidifier 50 according to the present embodiment will be described. In the humidifier 50 according to the present embodiment, when both of an air conditioning operation switch 102a and a humidifying operation switch 102b are turned on, the control device 100 controls the switching door 57 and the opening and closing door 58 to humidify the vehicle interior.

The control device 100 according to the present embodiment controls the switching door 57 and the opening and closing door 58 so as to alternately repeat desorption of the moisture adsorbed onto the adsorbent 511 and adsorption of the moisture to the adsorbent 511.

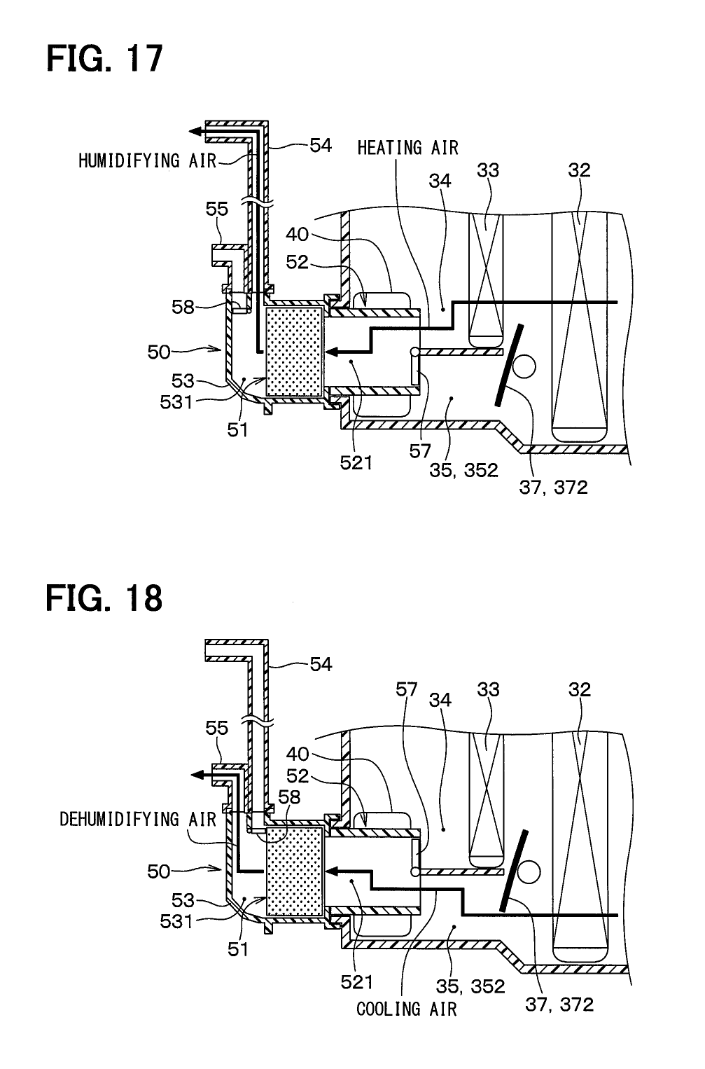

Specifically, when desorbing the moisture adsorbed onto the adsorbent 511, as shown in FIG. 17, the control device 100 controls a position of the switching door 57 so as to communicate between the hot air passage 34 and the humidity adjustment passage 521 and to block a communication between the cold air passage 35 and the humidity adjustment passage 521.

In addition, when desorbing the moisture adsorbed onto the adsorbent 511, the control device 100 controls a position of the opening and closing door 58 so as to communicate between the humidity adjustment passage 521 and the inside of the humidification duct 54 and to block a communication between the humidity adjustment passage 521 and the inside of the dehumidification duct 55.

As a result, a part of the heating air heated by the heating heat exchanger 33 is introduced into the connection portion 53 through the humidity adjustment passage 521. The heating air introduced into the connection portion 53 is humidified by desorption of the moisture adsorbed on the adsorbent 511 of the adsorber 51. Thereafter, the humidifying air humidified by the adsorbent 511 is blown toward a space to be humidified in the vehicle interior through the humidification duct 54.

On the other hand, when adsorbing the moisture to the adsorbent 511, as shown in FIG. 18, the control device 100 controls a position of the switching door 57 so as to communicate between the cold air passage 35 and the humidity adjustment passage 521 and to block a communication between the hot air passage 34 and the humidity adjustment passage 521.

In addition, when adsorbing the moisture to the adsorbent 511, the control device 100 controls a position of the opening and closing door 58 so as to communicate between the humidity adjustment passage 521 and the inside of the dehumidification duct 55 and to block a communication between the humidity adjustment passage 521 and the inside of the humidification duct 54.

As a result, a part of the cooling air cooled by the cooling heat exchanger 32 is introduced into the connection portion 53 through the humidity adjustment passage 521. The cooling air introduced into the connection portion 53 is dehumidified by absorption of the moisture by the adsorbent 511 of the adsorber 51. Thereafter, the dehumidifying air dehumidified by the adsorbent 511 is blown into the space inside the instrument panel 9 through the dehumidification duct 55.

The other configuration is the same as in the first embodiment. The air conditioning apparatus for a vehicle 1 according to the present embodiment has a configuration common to that of the first embodiment. For that reason, the air conditioning apparatus for a vehicle 1 according to the present embodiment can obtain the same advantages as those in the first embodiment, which are obtained from the configuration common to the first embodiment.

In particular, the present embodiment is provided with the switching door 57 that selectively introduces the heating air heated by the heating heat exchanger 33 and the cooling air cooled by the cooling heat exchanger 32 into the adsorbent 511.

According to the above configuration, the switching door 57 can alternately supply the heating air heated by the heating heat exchanger 33 and the cooling air cooled by the cooling heat exchanger 32 to the adsorber 51. With the above configuration, the air humidified by the adsorber 51 can be intermittently provided to the vehicle interior.

### First Modification of Third Embodiment

In the third embodiment described above, the example in which the switching door 57 for switching the air introduced into the humidity adjustment passage 521 is provided on the air inlet side of the humidity adjustment passage 521 has been described, but the present disclosure is not limited to the above configuration.

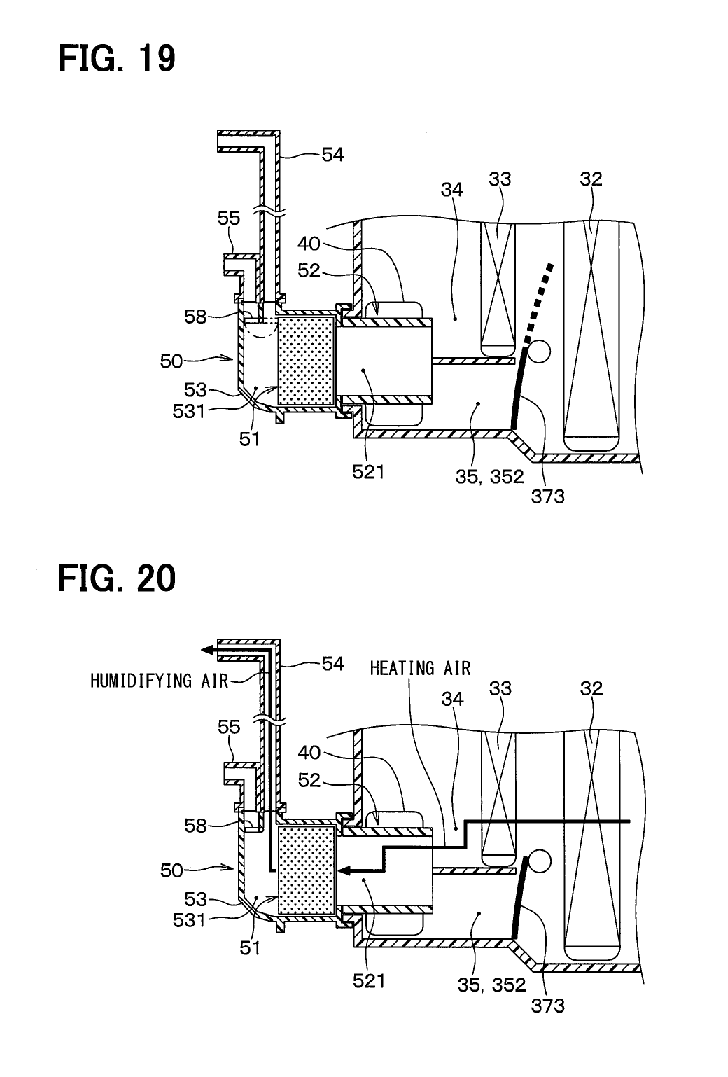

For example, as shown in FIG. 19, an intermediate door 373 for opening and closing the hot air passage 34 and the cold air passage 35 existing on the upstream side of the humidity adjustment passage 521 may be added, and the intermediate door 373 may be configured to switch the air introduced into the humidity adjustment passage 521.

In this example, the intermediate door 373 is configured to open and close the hot air passage 34 and the cold air passage 35 existing on the upstream side of the humidity adjustment passage 521, and the intermediate door 373 can be driven independently of the upper side door 371 and the lower side door 372 of the air mixing door 37 described in the first embodiment. In the present modification, the intermediate door 373 configures an introduction switching member which selectively introduces a heating air heated by a heating heat exchanger 33 and a cooling air cooled by a cooling heat exchanger 32 into the adsorber 51. In the present modification, the intermediate door 373 and the opening and closing door 58 function as a mixing inhibitor that inhibits the heating air and the cooling air from being mixed with each other and inhibits the dehumidifying air and the humidifying air from being mixed with each other in the air passage extending from the humidity adjustment passage 521 to the humidification duct 54.

The control device 100 according to the present modification controls the intermediate door 373 and the opening and closing door 58 so as to alternately repeat desorption of the moisture adsorbed onto the adsorbent 511 and adsorption of the moisture to the adsorbent 511.

Specifically, when desorbing the moisture adsorbed onto the adsorbent 511, as shown in FIG. 20, the control device 100 controls a position of the intermediate door 373 so as to communicate between the hot air passage 34 and the humidity adjustment passage 521 and to substantially block a communication between the cold air passage 35 and the humidity adjustment passage 521.

In addition, when desorbing the moisture adsorbed onto the adsorbent 511, the control device 100 controls a position of the opening and closing door 58 so as to communicate between the humidity adjustment passage 521 and the inside of the humidification duct 54 and to block a communication between the humidity adjustment passage 521 and the inside of the dehumidification duct 55.

As a result, a part of the heating air heated by the heating heat exchanger 33 is introduced into the connection portion 53 through the humidity adjustment passage 521. The heating air introduced into the connection portion 53 is humidified by desorption of the moisture adsorbed on the adsorbent 511 of the adsorber 51. Thereafter, the humidifying air humidified by the adsorbent 511 is blown toward a space to be humidified in the vehicle interior through the humidification duct 54.

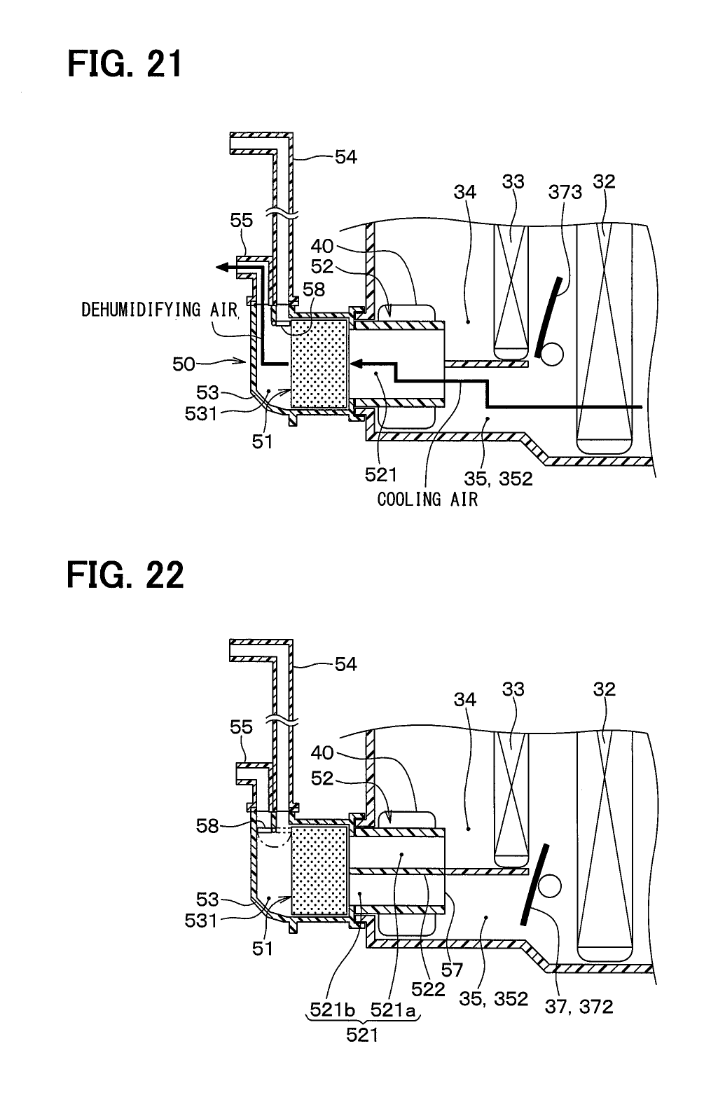

On the other hand, when adsorbing the moisture to the adsorbent 511, as shown in FIG. 21, the control device 100 controls a position of the intermediate door 373 so as to communicate between the cold air passage 35 and the humidity adjustment passage 521 and to substantially block a communication between the hot air passage 34 and the humidity adjustment passage 521.

In addition, when adsorbing the moisture to the adsorbent 511, the control device 100 controls a position of the opening and closing door 58 so as to communicate between the humidity adjustment passage 521 and the inside of the dehumidification duct 55 and to block a communication between the humidity adjustment passage 521 and the inside of the humidification duct 54.

As a result, a part of the cooling air cooled by the cooling heat exchanger 32 is introduced into the connection portion 53 through the humidity adjustment passage 521. The cooling air introduced into the connection portion 53 is dehumidified by absorption of the moisture by the adsorbent 511 of the adsorber 51. Thereafter, the dehumidifying air dehumidified by the adsorbent 511 is blown into the space inside the instrument panel 9 through the dehumidification duct 55.

The other configurations are identical with those in the third embodiment. Similarly, the air conditioning apparatus for a vehicle 1 according to the present modification can obtain the same advantages as those in the third embodiment, which are obtained from the configuration of the third embodiment.

### Second Modification of Third Embodiment

In the third embodiment described above, the example in which the partition plate 522 and the partition member 532 of the humidity adjustment passage 521 are eliminated and the switching door 57 for switching the air introduced into the humidity adjustment passage 521 is provided on the air inlet side of the humidity adjustment passage 521 has been described, but the present disclosure is not limited to the above configuration.

For example, as shown in FIG. 22, the partition plate 522 may be disposed inside the humidity adjustment passage 521. In other words, the humidity adjustment passage 521 according to the present modification is partitioned into the hot air introduction passage 521a through which a part of the heating air flows and the cold air introduction passage 521b through which a part of the cooling air flows.

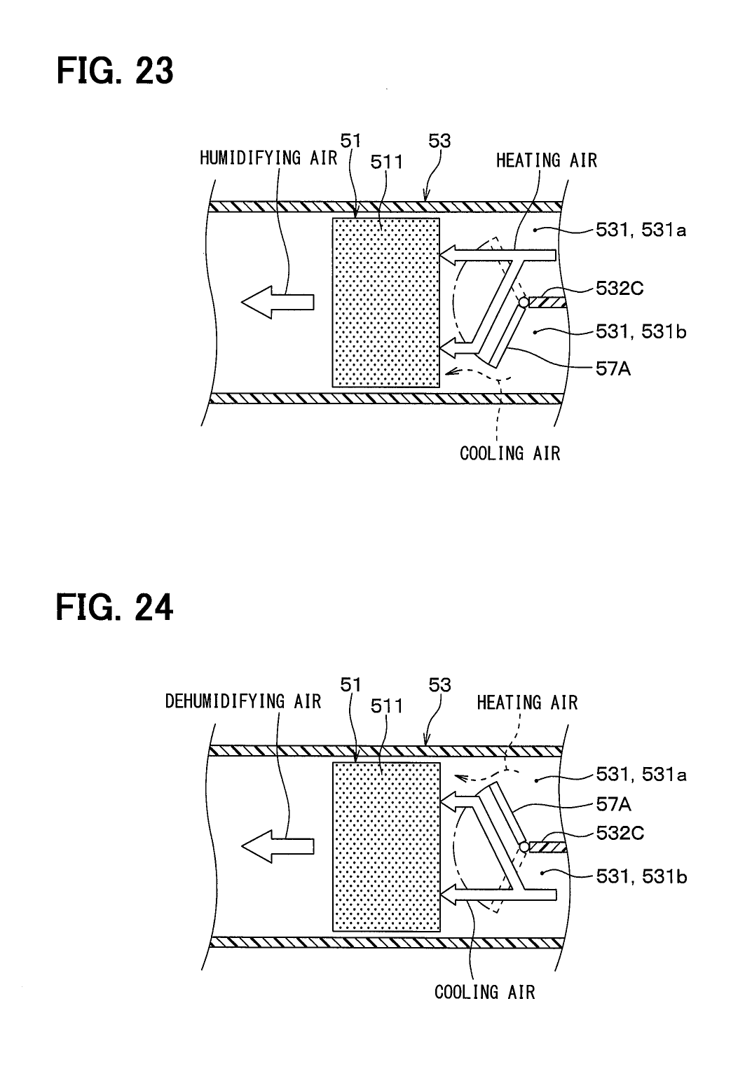

As shown in FIGS. 23 and 24, in the present modification, the air flow upstream side of the adsorber 51 in the space 531 in which the adsorber 51 is disposed is partitioned into a space that communicates with the hot air introduction passage 521a and a space that communicates with the cold air introduction passage 521b by the partition member 532C.

Furthermore, in the present modification, a switching door 57A for switching the air to be introduced into the adsorbent 511 is disposed on the air inlet side of the adsorber 51. In the present modification, the switching door 57A configures an introduction switching member which selectively introduces the heating air and the cooling air into the adsorber 51.

The switching door 57A according to the present modification is provided at a position facing the adsorber 51. The switching door 57A is provided so as to provide a predetermined gap between the switching door 57A and a surrounding member such as the adsorber 51 for the purpose of avoiding a contact with the surrounding member. In the present modification, the switching door 57A and the partition members 532C function as a mixing inhibitor that inhibits the heating air and the cooling air from being mixed with each other, in the air passage extending from the humidity adjustment passage 521 to the humidification duct 54.

The switching door 57A according to the present modification is connected to an output side of a control device 100. The operation of the switching door 57A is controlled according to a control signal from the control device 100. The control device 100 according to the present modification controls the switching door 57A so as to alternately repeat desorption of the moisture adsorbed onto the adsorbent 511 and adsorption of the moisture to the adsorbent 511.

Specifically, when desorbing the moisture adsorbed onto the adsorbent 511, as shown in FIG. 23, the control device 100 controls a position of the switching door 57A so as to communicate between the hot air introduction passage 521a and the adsorbent 511 and to block a communication between the cold air introduction passage 521b and the adsorbent 511.

As a result, a part of the heating air heated by the heating heat exchanger 33 is introduced into the adsorber 51 through the humidity adjustment passage 521. The introduced heating air is humidified by desorption of the moisture adsorbed onto the adsorbent 511 of the adsorber 51. At this time, a part of the cooling air may be mixed with the heating air through a gap between the switching door 57A and a portion around the switching door 57A as indicated by a broken line arrow in FIG. 23. For that reason, it is desirable that the gap between the switching door 57A and the portion around the switching door 57A is set to a size within a range where a temperature difference between the heating air and the cooling air flowing into the adsorber 51 can be secured.

On the other hand, when adsorbing the moisture onto the adsorbent 511, as shown in FIG. 24, the control device 100 controls a position of the switching door 57A so as to communicate between the cold air introduction passage 521b and the adsorbent 511 and to block a communication between the hot air introduction passage 521a and the adsorbent 511.

According to the above configuration, a part of the cooling air cooled by the cooling heat exchanger 32 is introduced into the adsorber 51 through the humidity adjustment passage 521. The introduced cooling air is dehumidified by adsorption of the moisture onto the adsorbent 511 of the adsorber 51. At this time, a part of the heating air may be mixed with the cooling air through a gap between the switching door 57A and a portion around the switching door 57A as indicated by a broken line arrow in FIG. 24. For that reason, it is desirable that the gap between the switching door 57A and the portion around the switching door 57A is set to a size within a range where a temperature difference between the heating air and the cooling air flowing into the adsorber 51 can be secured.

The other configurations are identical with those in the third embodiment. Similarly, the air conditioning apparatus for a vehicle 1 according to the present modification can obtain the same advantages as those in the third embodiment, which are obtained from the configuration of the third embodiment.

### Third Modification of Third Embodiment

In the third embodiment described above, the example in which the switching door 57 is provided on the air inlet side of the humidity adjustment passage 521, and the opening and closing door 58 is provided in the vicinity of the opening on the air flow upstream side of the humidification duct 54 and the dehumidification duct 55 has been described. However, the present disclosure is not limited to the above configuration.

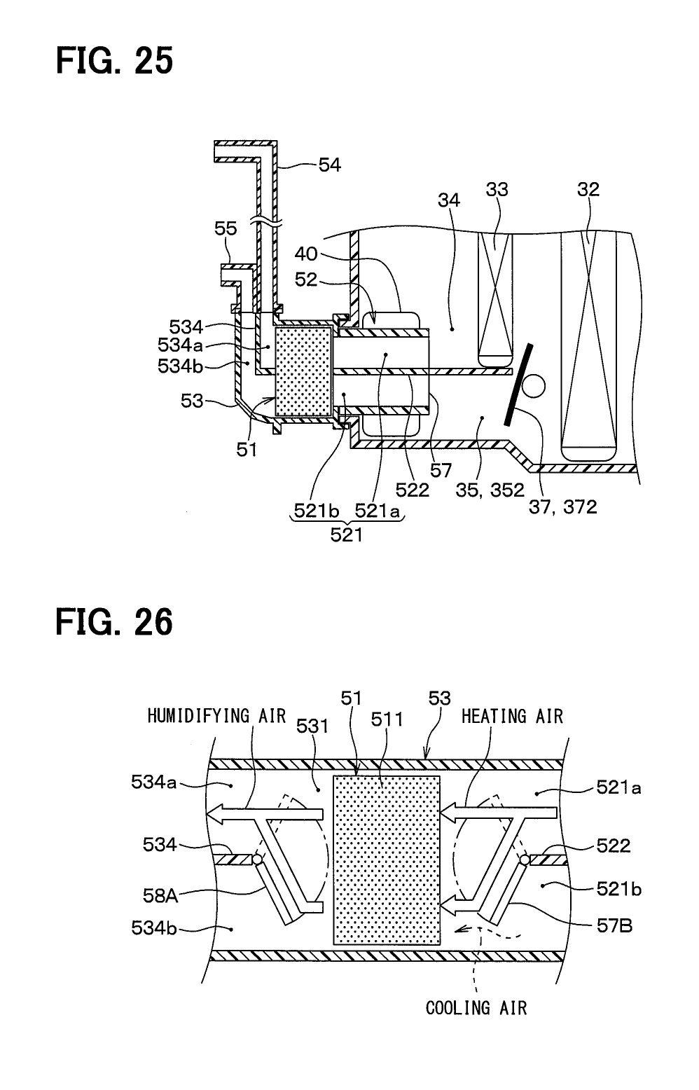

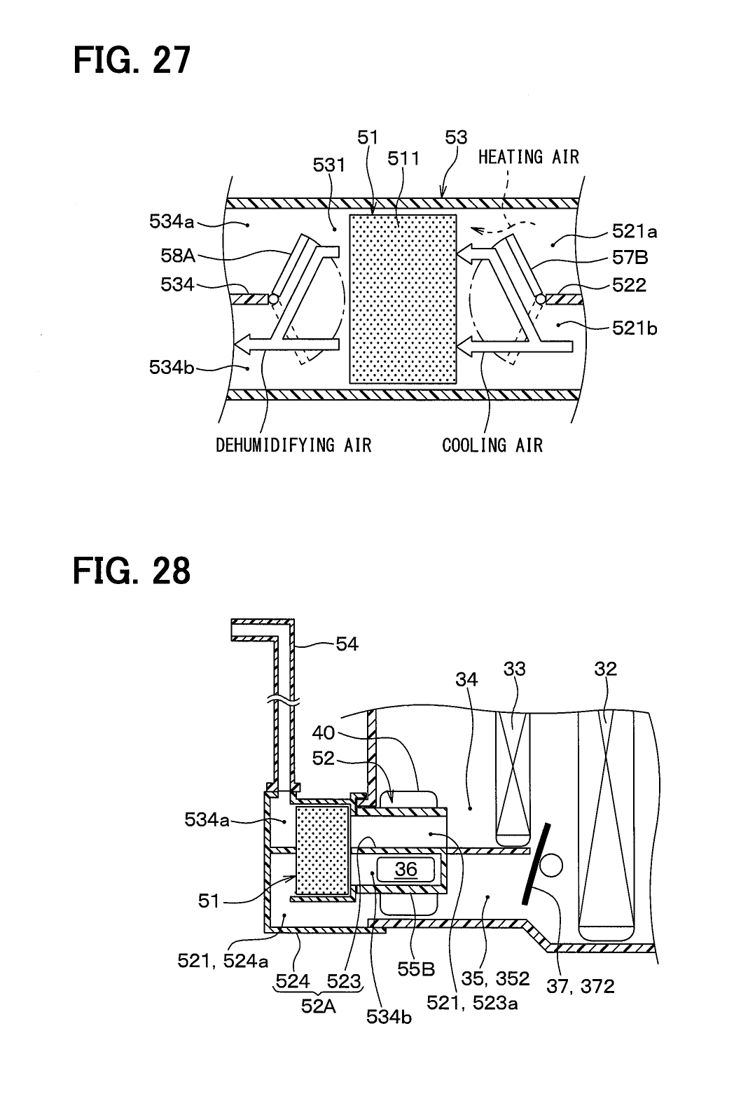

As shown in FIG. 25, in the configuration in which the air flow upstream side and the air flow downstream side of the air passage of the adsorber 51 are divided by a partition plate 522 and a partition portion 534, doors 57B and 58A may be disposed in the space 531 in which the adsorber 51 is accommodated as shown in FIGS. 26 and 27. The air flow upstream side of the adsorber 51 is divided into the hot air introduction passage 521a and the cold air introduction passage 521b by the partition plate 522. The air flow downstream side of the adsorber 51 is divided into a humidification passage 534a and a dehumidification passage 534b by the partition portion 534.

The switching door 57B configures an introduction switching member which selectively introduces the heating air and the cooling air into the adsorber 51. Further, the opening and closing door 58A configures a lead-out switching member for selectively leading out the humidifying air and the dehumidifying air generated by the adsorbent 511 from the adsorber 51.

The switching door 57B and the opening and closing door 58A according to the present modification are provided at a position facing the adsorber 51. The switching door 57B and the opening and closing door 58A are provided so as to provide a predetermined gap between the switching door 57A and a surrounding member such as the adsorber 51 for the purpose of avoiding a contact with the surrounding member. In the present modification, the switching door 57B and the opening and closing door 58A function as a mixing inhibitor that inhibits the heating air and the cooling air from being mixed with each other and inhibits the dehumidifying air and the humidifying air from being mixed with each other in the air passage extending from the humidity adjustment passage 521 to the humidification duct 54.

The switching door 57B and the opening and closing door 58A according to the present modification are connected to an output side of a control device 100. The operation of the switching door 57B and the opening and closing door 58A is controlled according to a control signal from the control device 100. The control device 100 according to the present modification controls the switching door 57B and the opening and closing door 58A so as to alternately repeat desorption of the moisture adsorbed onto the adsorbent 511 and adsorption of the moisture to the adsorbent 511.

Specifically, when desorbing the moisture adsorbed onto the adsorbent 511, as shown in FIG. 26, the control device 100 controls a position of the switching door 57B so as to communicate between the hot air introduction passage 521a and the adsorbent 511 and to block a communication between the cold air introduction passage 521b and the adsorbent 511.

In addition, when desorbing the moisture adsorbed onto the adsorbent 511, the control device 100 controls a position of the opening and closing door 58A so as to communicate between the humidification passage 534a and the adsorbent 511 and to block a communication between the dehumidification passage 534b and the adsorbent 511.

According to the above configuration, the space 531 in which the adsorber 51 is accommodated is in a humidification passage state in which the hot air introduction passage 521a and the humidification passage 534a communicate with each other in a state where the communication between the cold air introduction passage 521b and the dehumidification passage 534b is blocked. In the humidification passage state, a part of the heating air heated by the heating heat exchanger 33 is introduced into the adsorber 51 through the humidity adjustment passage 521. The introduced heating air is humidified by desorption of the moisture adsorbed onto the adsorbent 511 of the adsorber 51. At this time, a part of the cooling air may be mixed with the heating air through a gap between the switching door 57B and a portion around the switching door 57B as indicated by a broken line arrow in FIG. 26. For that reason, it is desirable that the gap between the switching door 57B and the portion around the switching door 57B is set to a size within a range where a temperature difference between the heating air and the cooling air flowing into the adsorber 51 can be secured.

On the other hand, when adsorbing the moisture onto the adsorbent 511, as shown in FIG. 27, the control device 100 controls a position of the switching door 57B so as to communicate between the cold air introduction passage 521b and the adsorbent 511 and to block a communication between the hot air introduction passage 521a and the adsorbent 511.

In addition, when adsorbing the moisture adsorbed onto the adsorbent 511, the control device 100 controls the opening and closing door 58A so as to communicate between the dehumidification passage 534b and the adsorbent 511 and to block a communication between the humidification passage 534a and the adsorbent 511.

According to the above configuration, the space 531 in which the adsorber 51 is accommodated is in a dehumidification passage state in which the cold air introduction passage 521b and the dehumidification passage 534b communicate with each other in a state where the communication between the hot air introduction passage 521a and the humidification passage 534a is blocked. In the dehumidification passage state, a part of the cooling air cooled by the cooling heat exchanger 32 is introduced into the adsorber 51 through the humidity adjustment passage 521. The introduced cooling air is dehumidified by adsorption of the moisture onto the adsorbent 511 of the adsorber 51. At this time, a part of the heating air may be mixed with the cooling air through a gap between the switching door 57B and a portion around the switching door 57B as indicated by a broken line arrow in FIG. 27. For that reason, it is desirable that the gap between the switching door 57B and the portion around the switching door 57B is set to a size within a range where a temperature difference between the heating air and the cooling air flowing into the adsorber 51 can be secured. In the present modification, the switching door 57B and the opening and closing door 58A configure a state switching member capable of switching between the humidification passage state and the dehumidification passage state.

The other configurations are identical with those in the third embodiment. Similarly, the air conditioning apparatus for a vehicle 1 according to the present modification can obtain the same advantages as those in the third embodiment, which are obtained from the configuration of the third embodiment.

### Fourth Modification of Third Embodiment

In the third modification described above, the example has been described in which an inflow direction of the heating air and an inflow direction of the cooling air relative to the adsorber 51 are the same direction and an outflow direction of the humidifying air and an outflow direction of the dehumidifying air are the same direction. However, the present disclosure is not limited to the above configuration.

In the present modification, an example will be described in which the inflow direction of the heating air and the inflow direction of the cooling air relative to the adsorber 51 are opposite to each other and the outflow direction of the humidifying air and the outflow direction of the dehumidifying air are opposite to each other.

As shown in FIG. 28, the passage formation member 52A according to the present modification includes a heating air duct 523 for guiding the heating air to the adsorber 51 and a cooling air duct 524 for guiding the cooling air to the adsorber 51. The humidity adjustment passage 521 according to the present modification is provided inside the heating air duct 523 and the cooling air duct 524. In other words, the humidity adjustment passage 521 according to the present modification is configured by a hot air introduction passage 523a provided inside the heating air duct 523 and a cold air introduction passage 524a provided inside the cooling air duct 524.

The cooling air duct 524 according to the present modification is connected to a portion of the adsorber 51 on a side opposite to a portion to which the heating air duct 523 is connected so that the inflow direction of the cooling air is opposite to the inflow direction of the heating air.

For example, a dehumidification duct 55C according to the present modification is connected to a portion defining the temperature adjustment space 36 inside the air conditioning case 31 so that the dehumidifying air dehumidified by the adsorbent 511 is introduced into the temperature adjustment space 36. More specifically, the dehumidification duct 55C according to the present modification is connected to a portion of the adsorber 51 on a side opposite to a portion to which the humidification duct 54 is connected so that the inflow direction of the dehumidifying air is opposite to the inflow direction of the humidifying air.

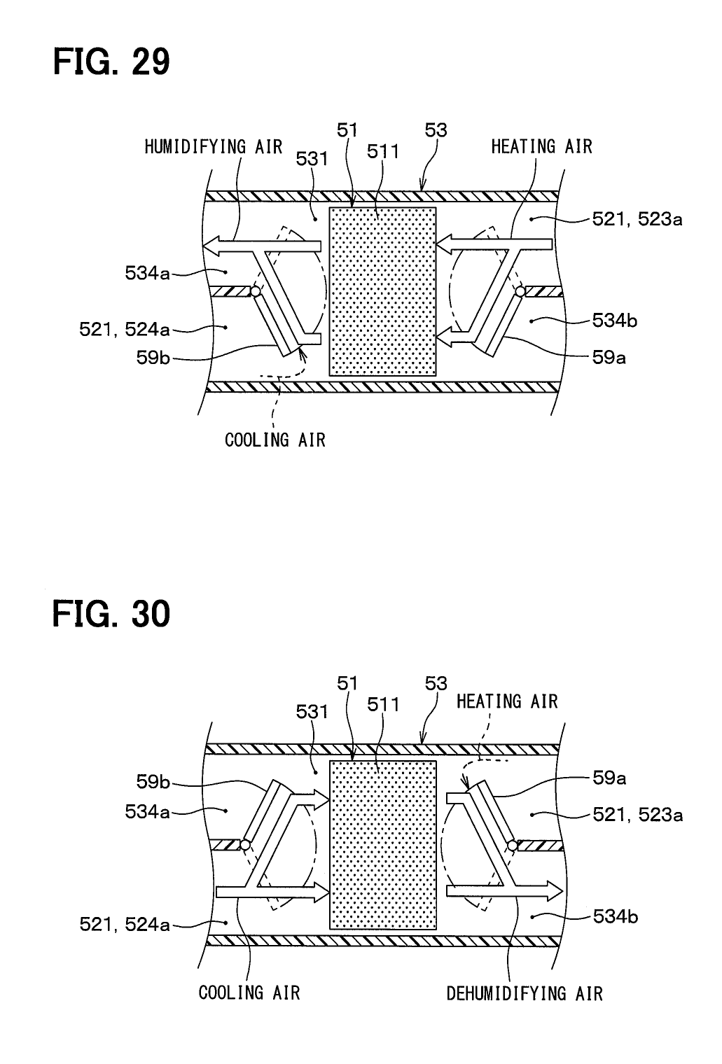

In the present modification, as shown in FIGS. 29 and 30, a first switching door 59a and a second switching door 59b are disposed in the space 531 where the adsorber 51 is accommodated. In the present modification, the first switching door 59a and the second switching door 59b function as a mixing inhibitor that inhibits the heating air and the cooling air from being mixed with each other and inhibits the dehumidifying air and the humidifying air from being mixed with each other in the air passage extending from the humidity adjustment passage 521 to the humidification duct 54.

The first switching door 59a selectively opens and closes the hot air introduction passage 523a and the dehumidification passage 534b inside the dehumidification duct 55C. The second switching door 59b selectively opens and closes the cold air introduction passage 524a and the humidification passage 534a inside the humidification duct 54.

The first switching door 59a and the second switching door 59b according to the present modification are provided at a position facing the adsorber 51. The first switching door 59a and the second switching door 59b are provided so as to provide a predetermined gap between those switching doors and a surrounding member such as the adsorber 51 for the purpose of avoiding a contact with the surrounding member.

In addition, the first switching door 59a and the second switching door 59b according to the present modification are connected to an output side of the control device 100. The operation of the first switching door 59a and the second switching door 59b is controlled according to a control signal from the control device 100. The control device 100 according to the present modification controls the first switching door 59a and the second switching door 59b so as to alternately repeat desorption of the moisture adsorbed onto the adsorbent 511 and adsorption of the moisture to the adsorbent 511.

Specifically, when desorbing the moisture adsorbed onto the adsorbent 511, as shown in FIG. 29, the control device 100 controls a position of the first switching door 59a so as to communicate between the hot air introduction passage 523a and the adsorbent 511 and to block a communication between the dehumidification passage 534b and the adsorbent 511.

In addition, when desorbing the moisture adsorbed onto the adsorbent 511, the control device 100 controls a position of the second switching door 59b so as to communicate between the humidification passage 534a and the adsorbent 511 and to block a communication between the cold air introduction passage 524a and the adsorbent 511.

According to the above configuration, the space 531 in which the adsorber 51 is accommodated is in a humidification passage state in which the hot air introduction passage 523a and the humidification passage 534a communicate with each other in a state where the communication between the cold air introduction passage 524a and the dehumidification passage 534b is blocked. In the humidification passage state, a part of the heating air heated by the heating heat exchanger 33 is introduced into the adsorber 51 through the humidity adjustment passage 521. The introduced heating air is humidified by desorption of the moisture adsorbed onto the adsorbent 511 of the adsorber 51. At this time, a part of the cooling air may be mixed with the humidifying air through a gap between the second switching door 59b and a portion around the second switching door 59b as indicated by a broken line arrow in FIG. 29. For that reason, it is desirable that the gap between the second switching door 59b and the portion around the second switching door 59b is set to a size within a range where a high humidity of the humidifying air flowing into the adsorber 51 is maintained.

On the other hand, when adsorbing the moisture onto the adsorbent 511, as shown in FIG. 30, the control device 100 controls a position of the first switching door 59a so as to communicate between the dehumidification passage 534b and the adsorbent 511 and to block a communication between the hot air introduction passage 523a and the adsorbent 511.

In addition, when desorbing the moisture adsorbed onto the adsorbent 511, the control device 100 controls a position of the second switching door 59b so as to communicate between the cold air introduction passage 524a and the adsorbent 511 and to block a communication between the humidification passage 534a and the adsorbent 511.

According to the above configuration, the space 531 in which the adsorber 51 is accommodated is in a dehumidification passage state in which the cold air introduction passage 524a and the dehumidification passage 534b communicate with each other in a state where the communication between the hot air introduction passage 523a and the humidification passage 534a is blocked. In the dehumidification passage state, a part of the cooling air cooled by the cooling heat exchanger 32 is introduced into the adsorber 51 through the humidity adjustment passage 521. The introduced cooling air is dehumidified by adsorption of the moisture onto the adsorbent 511 of the adsorber 51. At this time, a part of the heating air may be mixed with the dehumidifying air through a gap between the first switching door 59a and a portion around the first switching door 59a as indicated by a broken line arrow in FIG. 30. For that reason, it is desirable that the gap between the first switching door 59a and the portion around the first switching door 59a is set to a size within a range where a low humidity of the dehumidifying air flowing into the adsorber 51 is maintained.

In the present modification, the first switching door 59a and the second switching door 59b configure a state switching member capable of switching between the humidification passage state and the dehumidification passage state.

The other configurations are identical with those in the third embodiment. Similarly, the air conditioning apparatus for a vehicle 1 according to the present modification can obtain the same advantages as those in the third embodiment, which are obtained from the configuration of the third embodiment.

### Other Embodiments

The typical embodiments disclosed in the present disclosure have been described above. However, the present disclosure is not limited to the embodiments described above, but can be variously modified.

In the respective embodiments described above, the example in which the evaporator is used as the cooling device for cooling the air flowing inside the air conditioning case 31 has been described, but the present disclosure is not limited to the above configuration. In addition to the evaporator, the cooling device may be configured by an air to air heat exchanger which cools the air flowing inside the air conditioning case 31 with the use of a Peltier module or a low temperature air such as an outside air.

Further, in the respective embodiments described above, the example in which the heater core is used as the heating device for heating the air flowing inside the air conditioning case 31 has been described, but the present disclosure is not limited to the above configuration. In addition to the heater core, the heating device may be configured by, for example, a Peltier module or an electric heater.

In the respective embodiments described above, the example in which the heating heat exchanger 33 is disposed on the air flow downstream side of the cooling heat exchanger 32 inside the HVAC 10 has been described, but the present disclosure is not limited to the above configuration. For example, the HVAC 10 may be configured such that the cooling heat exchanger 32 and the heating heat exchanger 33 are disposed in parallel to the air flow.

In the respective embodiments described above, the example in which the cold air passage 35 is divided into the two air flow passages of the upper side cold air passage 351 and the lower side cold air passage 352 has been described, but the present disclosure is not limited to the above configuration. For example, the cold air passage 35 may be provided as a single air flow passage.

In this case, as in the respective embodiments described above, it is desirable to provide the passage formation member 52 providing the humidity adjustment passage 521 substantially in the center in the right-left direction inside the air conditioning case 31, but the present disclosure is not limited to the above configuration. For example, the passage formation member 52 may be disposed so as to be biased toward one side in the right-left direction inside the air conditioning case 31.

Further, in the respective embodiments described above, the example in which the humidity adjustment passage 521 is provided by the passage formation member 52 configured as a separate part from the air conditioning case 31, but the present disclosure is not limited to the above configuration. For example, the humidity adjustment passage 521 may be provided by leveraging a rib erected inside the air conditioning case 31.

In the respective embodiments described above, the example in which the outlet side portion of the passage formation member 52 and the inlet side portion of the humidification duct 54 which will be described later are connected to each other through the connection portion 53 configured as a separate part from the air conditioning case 31 has been described, but the present disclosure is not limited to the above configuration. For example, the outlet side portion of the passage formation member 52 and the inlet side portion of the humidification duct 54 to be described later may be connected directly to the intermediate opening portion 41 of the air conditioning case 31. In that case, the intermediate opening portion 41 of the air conditioning case 31 configures a connection portion for connecting the outlet side portion of the passage formation member 52 and the inlet side portion of the humidification duct 54 which will be described later.

Although it is desirable to dispose the adsorber 51 in the connection portion 53 as in the embodiments described above, the present disclosure is not limited to the above configuration. For example, a part of the adsorber 51 may be disposed so as to be hooked on the humidity adjustment passage 521, or a part of the adsorber 51 may be disposed at a position to be hooked on a part of the humidification duct 54 and the dehumidification duct 55.

In the first and second embodiments described above, the example has been described in which an inflow direction of the heating air and an inflow direction of the cooling air relative to the adsorber 51 are the same direction and an outflow direction of the humidifying air and an outflow direction of the dehumidifying air are the same direction. However, the present disclosure is not limited to the above configuration. The air conditioning apparatus 1 for a vehicle according to the first and second embodiments may be configured such that the inflow direction of the heating air and the inflow direction of the cooling air relative to the adsorber 51 are opposite to each other and the outflow direction of the humidifying air and the outflow direction of the dehumidifying air are opposite to each other.

In the respective embodiments described above, elements configuring the embodiments are not necessarily indispensable as a matter of course, except when the elements are particularly specified as indispensable and the elements are considered as obviously indispensable in principle.

In the respective embodiments described above, when numerical values such as the number, figures, quantity, a range of configuration elements in the embodiments are described, the numerical values are not limited to a specific number, except when the elements are particularly specified as indispensable and the numerical values are obviously limited to the specific number in principle.

In the respective embodiments described above, when a shape, and a positional relationship of the configuration elements are described, the configuration elements are not limited to the shape, and the positional relationship, except when the configuration elements are particularly specified and are limited to a specific shape, and positional relationship in principle.

### (Overview)

According to a first aspect shown in a part or whole of the embodiments described above, an air conditioning apparatus for a vehicle includes an adsorber having an adsorbent capable of adsorbing and desorbing moisture, and a humidification duct connected to an air conditioning case, and configured to guide a humidifying air, which has been humidified by moisture desorbed from the adsorbent, into a vehicle interior. A temperature adjustment space, into which an cooling air cooled by the cooling device and a heating air heated by a heating device flow, and a humidity adjustment passage, which guides the heating air to the adsorbent and guides the cooling air to the adsorbent, are provided in the air conditioning case and positioned downstream of the cooling device and the heating device in an air flow. In addition, the air conditioning apparatus for a vehicle includes a mixing inhibitor that inhibits mixing of the heating air and the cooling air and inhibits mixing of the humidifying air and a dehumidifying air which has been dehumidified via adsorption of moisture by the adsorber, and the mixing inhibitor is provided in an air passage extending from the humidity adjustment passage to the humidification duct.

In addition, according to a second aspect, the air conditioning case includes therein a passage formation member that defines the humidity adjustment passage and separates the humidity adjustment passage from the temperature adjustment space.

According to the above configuration, airs passing through the cooling device and the heating device can be properly distributed to the temperature adjustment space and the humidity adjustment passage. For that reason, the vehicle interior can be humidified while exercising the function of adjusting the temperature in the vehicle interior in the air conditioning apparatus for a vehicle.

In addition, according to a third aspect, in the air conditioning apparatus for a vehicle, the passage formation member is provided inside the air conditioning case and divides a part of the temperature adjustment space into a right temperature adjustment space for mainly adjusting a temperature of the air blown into a space of the vehicle interior where a right seat is disposed, and a left temperature adjustment space for mainly adjusting the temperature of the air blown into a space of the vehicle interior where a left seat is disposed.

As described above, the passage formation member defining the humidity adjustment passage is provided inside the air conditioning case such that a part of the temperature adjustment space is divided into the right temperature adjustment space and the left temperature adjustment space. As a result, the right side and the left side of the temperature adjustment space can be configured as symmetric spaces. This is effective for equally maintaining the air conditioning functions exerted on the space where the right seat is placed and the space where the left seat is placed in the vehicle interior.

Further, according to a fourth embodiment, in the air conditioning apparatus for a vehicle, at least a part of the adsorber is disposed inside a connection portion that connects an outlet side portion of the humidity adjustment passage and an inlet side portion of the humidification duct. As described above, when at least a part of the adsorbent is disposed in the connection portion connecting the outlet side portion of the humidity adjustment passage and the inlet side portion of the humidification duct, a change in size of the temperature adjustment space inside the air conditioning case due to addition of the adsorber can be reduced.

According to a fifth aspect, in the air conditioning apparatus for a vehicle, the air conditioning case is connected to a circulation duct configured to return the dehumidifying air to an air-flow upstream side of the cooling device.

As described above, according to the configuration in which the dehumidifying air dehumidified by the adsorbent is returned to the air-flow upstream side of the cooling device, the dehumidifying air which has been dehumidified by the adsorbent can be prevented from being supplied into the vehicle interior, and therefore the vehicle interior can be sufficiently humidified.

According to a sixth aspect, in the air conditioning apparatus for a vehicle, the mixing inhibitor includes an introduction switching member configured to selectively introduce the heating air and the cooling air into the adsorber. According to the above configuration, the cooling air and the heating air can be alternately supplied to the adsorber by the switching member. With the above configuration, the air humidified by the adsorber can be intermittently provided to the vehicle interior.

According to a seventh aspect, in the air conditioning apparatus for a vehicle, the mixing inhibitor includes a partition forming portion disposed upstream of the adsorber in the air flow and defining and partitioning a hot air introduction passage through which the heating air flows and a cold air introduction passage through which the cooling air flows.

As described above, according to the configuration in which the hot air introduction passage and the cold air introduction passage are separated by the partition forming portion, the heat loss caused by mixing of the heating air and the cooling air on the air-flow upstream side of the adsorber can be sufficiently reduced.

According to an eighth aspect, in the air conditioning apparatus for a vehicle, the mixing inhibitor includes a state switching member configured to switch between a humidification passage state and a dehumidification passage state. The humidification passage state is a state in which a hot air introduction passage communicates with a humidification passage while a communication between a cold air introduction passage and a dehumidification passage is blocked. The dehumidification passage state is a state in which the cold air introduction passage communicates with the dehumidification passage while a communication between the hot air introduction passage and the humidification passage is blocked.

According to the above configuration, the heat loss caused by mixing of the heating air and the cooling air can be sufficiently reduced, and deterioration of a humidifying effect in the vehicle interior due to mixing of the humidifying air and the dehumidifying air can be sufficiently reduced.

Furthermore, according to a ninth aspect, in the air conditioning apparatus for a vehicle, a space in which the adsorber is housed is partitioned into a moisture desorption space through which the heating air flows and a moisture absorption space through which the cooling air flows. Further, the adsorber is connected with a drive mechanism configured to rotate the adsorber such that at least a part of the adsorbent existing in the moisture absorption space is moved to the moisture desorption space and at least a part of the adsorbent existing in the moisture desorption space is moved to the moisture absorption space.

As described above, by rotating the adsorber, the moisture adsorbed onto the adsorbent in the moisture absorption space can be desorbed in the moisture desorption space, and the moisture of the air flowing in the moisture absorption space can be adsorbed onto the adsorber from which the moisture is desorbed in the moisture desorption space. According to the above configuration, the air humidified by the adsorber can be continuously provided to the vehicle interior.

In addition, according to a tenth aspect, the air conditioning apparatus for a vehicle includes a partitioning member that partitions at least a part of the space in which the adsorber is accommodated into the moisture desorption space and the moisture absorption space. According to the above configuration, the heat loss caused by mixing of the heating air and the cooling air can be sufficiently reduced, and the deterioration of the humidifying effect in the vehicle interior due to mixing of the humidifying air and the dehumidifying air can be sufficiently reduced.

What is claimed is:

1. An air conditioning apparatus for a vehicle, which air-conditions a vehicle interior, the air conditioning apparatus comprising:
an air conditioning case having an air flow passage of the air to be blown into the vehicle interior;
a cooling device housed inside the air conditioning case and configured to cool the air circulating inside the air conditioning case;
a heating device housed inside the air conditioning case and configured to heat the air circulating inside the air conditioning case;
an adsorber including an adsorbent capable of adsorbing and desorbing moisture; and
a humidification duct connected to the air conditioning case and configured to guide a humidifying air, which has been humidified by moisture desorbed from the adsorbent, into the vehicle interior, wherein
the air conditioning case includes:
a temperature adjustment space configured to introduce thereinto a cooling air cooled by the cooling device and a heating air heated by the heating device; and
a humidity adjustment passage configured to guide a part of the heating air to the adsorbent as an air desorbing moisture from the adsorbent, and guide a part of the cooling air to the adsorbent as an air having moisture to be adsorbed by the adsorbent,
the temperature regulation space and the humidity adjustment passage are provided in the air conditioning case and located downstream of the cooling device and the heating device in an air flow, and
a mixing inhibitor is disposed in an air passage extending from the humidity adjustment passage to the humidification duct, and is configured to inhibit mixing of the heating air and the cooling air and inhibit mixing of the humidifying air and a dehumidifying air which has been dehumidified via adsorption of moisture by the adsorber.

2. The air conditioning apparatus for a vehicle, according to claim 1, wherein the air conditioning case includes therein a passage formation member that defines the humidity adjustment passage and separates the humidity adjustment passage from the temperature adjustment space.

3. The air conditioning apparatus for a vehicle, according to claim 2, wherein the passage formation member is provided inside the air conditioning case and divides a part of the temperature adjustment space into a right temperature adjustment space for mainly adjusting a temperature of the air blown into a space of the vehicle interior where a right seat is disposed, and a left temperature adjustment space for mainly adjusting the temperature of the air blown into a space of the vehicle interior where a left seat is disposed.

4. The air conditioning apparatus for a vehicle, according to claim 1, wherein at least a part of the adsorber is disposed inside a connection portion connecting an outlet side portion of the humidity adjustment passage and an inlet side portion of the humidification duct.

5. The air conditioning apparatus for a vehicle, according to claim 1, wherein the air conditioning case is connected to a circulation duct configured to return the dehumidifying air to an upstream side of the cooling device in the air flow.

6. The air conditioning apparatus for a vehicle, according to claim 1, wherein the mixing inhibitor includes an introduction switching member configured to selectively introduce the heating air and the cooling air into the adsorber.

7. The air conditioning apparatus for a vehicle, according to claim 6, wherein the mixing inhibitor includes a partition forming portion disposed upstream of the adsorber in the air flow and defining and partitioning a hot air introduction passage through which the heating air flows and a cold air introduction passage through which the cooling air flows.

8. The air conditioning apparatus for a vehicle, according to claim 1, wherein
the mixing inhibitor includes a state switching member configured to switch between a humidification passage state and a dehumidification passage state,
the humidification passage state is a state in which a hot air introduction passage through which the heating air flows communicates with a humidification passage through which the humidifying air flows while a communication between a cold air introduction passage through which the cooling air flows and a dehumidification passage through which the dehumidifying air flows is blocked, and
the dehumidification passage state is a state in which the cold air introduction passage communicates with the dehumidification passage while a communication between the hot air introduction passage and the humidification passage is blocked.

9. The air conditioning apparatus for a vehicle, according to claim 1, wherein
a space in which the adsorber is housed is partitioned into a moisture desorption space through which the heating air flows and a moisture absorption space through which the cooling air flows, and
the adsorber is connected with a drive mechanism configured to rotate the adsorber such that at least a part of the adsorbent existing in the moisture absorption space is moved to the moisture desorption space and at least a part of the adsorbent existing in the moisture desorption space is moved to the moisture absorption space.

10. The air conditioning apparatus for a vehicle, according to claim 9, wherein the mixing inhibitor includes a partitioning member partitioning at least a part of the space, in which the adsorber is housed, into the moisture desorption space and the moisture absorption space.
